(19) United States
(12) Patent Application Publication
(10) Pub. No.: US 2015/0206232 A1
(43) Pub. Date: Jul. 23, 2015

(54) Method and system for enabling and managing subcontracting remote laboratories

(71) Applicants: Jeffrey Morris Cogen, Flemington, NJ (US); Vivek Tomer, Philadelphia, PA (US)

(72) Inventors: Jeffrey Morris Cogen, Flemington, NJ (US); Vivek Tomer, Philadelphia, PA (US)

(21) Appl. No.: 14/598,841

(22) Filed: Jan. 16, 2015

Related U.S. Application Data
(60) Provisional application No. 61/965,058, filed on Jan. 18, 2014.

(51) Int. Cl. G06Q 30/08; G06Q 50/20

(52) U.S. Cl. CPC G06Q 30/08; G06Q 50/20

(57) ABSTRACT

A method of facilitating a remote laboratory bid process includes generating an online educational institution-associated bid request utilizing at least a portion of bid item selections of a stored bid item list, transmitting the online educational institution-associated bid request to a remote laboratory agent for solicitation of a remote laboratory agent bid response to be generated with the bid item selections utilized in the online educational institution-associated bid request, generating a remote laboratory agent-associated bid request utilizing at least a portion of the bid item selections utilized in the online educational institution-associated bid request, and transmitting the remote laboratory agent-associated bid request to at least one sub-contracting remote laboratory for solicitation of a sub-contracting remote laboratory bid response to be generated with the bid item selections utilized in the remote laboratory agent-associated bid request.

### CROSS-REFERENCE TO RELATED APPLICATIONS

This U.S. non-provisional application claims the benefit of the priority date of U.S. provisional application 61/965,058, filed Jan. 18, 2014.

### BACKGROUND OF THE INVENTION

1. Technical Field

The present invention relates generally to a method of and system for enabling and managing sub-contracting remote laboratories. More particularly, and by way of example, the present invention relates to electronically facilitating various aspects of sub-contracting remote laboratory (SCRL) utilization relative to in person laboratory components of online courses, including, but not limited to, SCRL enablement, a remote laboratory bid process, and a requisition process.

2. History of Related Art

Colleges and universities are increasingly offering at least some of their courses online, i.e. they are online colleges and universities (on line educational institutions). Online courses are defined here as courses that do not require classroom attendance for the majority of the coursework, attendance being replaced by some combination of one or more of Internet, video, computer, tablet or phone learning. While online courses work well for many subjects, some subjects traditionally involve hands-on laboratory instruction. This is especially the case for some fields with the most promising employment prospects, such as sciences and engineering. Chemistry, Biology, Engineering, Physics, Botany, and Biochemistry are just some examples of subjects that typically require extensive hands-on laboratory education. Some other examples include medical and related sciences, electronics technology, information technology, automobile technical training and computer networking. This poses a challenge for online colleges and universities and students. Students increasingly wish to take online courses, and colleges and universities wish to meet student needs by offering online courses and degrees. Yet, some of the most promising fields do not readily lend themselves to an exclusively online learning curriculum on account of a need for hands-on laboratory training.

To remedy this, online colleges and universities may in some cases require students of online courses to spend time in residence at the campuses of the online colleges and universities to complete hands-on laboratory course work. This presents a difficulty for the students, because many students that take online courses live far away from the campuses of the online colleges or universities where they wish to take on line courses, in some cases even in other countries or on other continents. In some cases, online colleges or universities may accept credits for courses that the student has completed at a second college or university, such courses comprising at least a non-laboratory component and optionally comprising a laboratory component, both of which are completed at the different college or university. Such is the case when a student transfers full course credits from another, second college or university. For several reasons, having students complete full courses at a second college or university is not ideal, including loss of business for the online college or university, inability of the online college or university to standardize the education received by the student, necessity for the student desiring online learning at the online college or university to complete the non-laboratory coursework in a remote non-online environment at the second college or university, and a general difficulty in coordinating such coursework toward completion of a degree (bachelor's, associates, Ph.D., or other degree or certification). In other cases, online colleges and universities may altogether forego hands-on laboratory training and instead require their students to do virtual laboratories in which they watch videos or view online pictures of key laboratory procedures. These virtual laboratories do not provide the hands-on training needed to master many experimental techniques, and it is likely that a significant number of selective employers will place a relatively low value on science and engineering degrees and other degrees and certifications that are earned without completing extensive hands-on laboratory training.

In another approach that can be conceived of, an online college or university may offer an online lecture portion of a course, but may require the student to travel for a period of time to the campus of the online college or university to complete the laboratory portion of the course. In this case, though it would have the advantage of including hands-on laboratory training, it would have the disadvantage of requiring the student to travel to and be in residence at the campus of the online college or university for a period of time.

Patent application U.S. 20140304300 A1 describes a system and method for facilitating completion of a laboratory section of a course at a location close to the online student, and integrating data pertaining to completion of the laboratory section of the course with data pertaining to completion of the online portion of the course to provide a complete course and curriculum record. It also discloses a system configured to offer online students opportunities for completing laboratory sections of courses at a location close to the online student as part of an overall at least partially online curriculum offering.

To effectively carry out the system and method described in patent application U.S. 20140304300 A1, it is necessary to have the on line educational institutions contract with remote laboratory providers to offer laboratory portions of courses in one or more locations close to the on line students but remote from the online educational institution. The remote laboratory providers are referred to hereinafter as sub-contracting remote laboratories (SCRLs).

### SUMMARY OF THE INVENTION

A method of facilitating a remote laboratory bid process includes generating an online educational institution-associated bid request utilizing at least a portion of bid item selections of a stored bid item list, transmitting the online educational institution-associated bid request to at least one remote laboratory agent for solicitation of a remote laboratory agent bid response to be generated with the bid item selections utilized in the online educational institution-associated bid request, generating a remote laboratory agent-associated bid request utilizing at least a portion of the bid item selections utilized in the online educational institution-associated bid request, and transmitting the remote laboratory agent-associated bid request to at least one sub-contracting remote laboratory (or executing a query of the remote laboratory agent-associated bid request to a database comprising records pertaining to at least one sub-contracting remote laboratory) for solicitation of a sub-contracting remote laboratory bid response to be generated with the bid item selections utilized in the remote laboratory agent-associated bid request.

A computer system for facilitating a bid process for a course involving an online educational institution, a remote laboratory agent, and at least one sub-contracting remote laboratory includes a database system for maintaining a configurable pre-established bid item list and a bid tem plate for the course and a server connected to the database system and connectable to the online educational institution, the remote laboratory agent, and the at least one sub-contracting remote laboratory (or to records pertaining to the at least one sub-contracting remote laboratory). The bid template includes bid item selections selected from the bid item list. The server is operable to generate an online educational institution-associated bid request utilizing the bid template, transmit the online educational institution-associated bid request to the remote laboratory agent, generate a remote laboratory agent-associated bid request via a parsing of the remote laboratory agent-associated bid request, transmit the remote laboratory agent-associated bid request to the at least one sub-contracting remote laboratory, receive a sub-contracting remote laboratory bid response to the remote laboratory agent-associated bid request, and receive a remote laboratory agent bid response. The remote laboratory agent bid response incorporates, at least in part, data from the sub-contracting remote laboratory bid response.

In a computer readable medium having computer-executable instructions stored thereon, the computer-executable instructions include means for generating an online educational institution-associated bid request utilizing at least a portion of bid item selections of a stored bid item list, means for transmitting the online educational institution-associated bid request to at least one remote laboratory agent for solicitation of a remote laboratory agent bid response to be generated with the bid item selections utilized in the online educational institution-associated bid request, means for generating a remote laboratory agent-associated bid request utilizing at least a portion of the bid item selections utilized in the online educational institution-associated bid request, and means for transmitting the remote laboratory agent-associated bid request to at least one sub-contracting remote laboratory for solicitation of a sub-contracting remote laboratory bid response to be generated with the bid item selections utilized in the remote laboratory agent-associated bid request.

A method of managing a remote laboratory bid process includes receiving an enablement request relative to a sub-contracting remote laboratory and receiving an affiliation request relative to a primary remote laboratory agent. The affiliation request requests that the sub-contracting remote laboratory be affiliated with the primary remote laboratory agent. The method also includes transmitting an online educational institution-associated bid request to the remote laboratory agent, transmitting, to the sub-contracting remote laboratory, of a daisy chain quotation associated with the online educational institution-associated bid request, and receiving a completed daisy chain quotation from the sub-contracting remote laboratory. The completed daisy chain quotation includes completed applicable daisy chain quotation items of the daisy chain quotation transmitted to the sub-contracting remote laboratory. The method also includes updating a remote laboratory agent bid response to the online educational institution-associated bid request using at least some of the completed applicable daisy chain quotation items and transmitting the updated remote laboratory agent bid response to the online educational institution.

In a computer readable medium having computer-executable instructions stored thereon, the computer-executable instructions include means for receiving an enablement request relative to a sub-contracting remote laboratory, means for receiving an affiliation request relative to a primary remote laboratory agent, the affiliation request requesting that the sub-contracting remote laboratory be affiliated with the primary remote laboratory agent, means for transmitting an online educational institution-associated bid request to the remote laboratory agent, means for transmitting, to the sub-contracting remote laboratory, of a daisy chain quotation associated with the online educational institution-associated bid request, and means for receiving a completed daisy chain quotation from the sub-contracting remote laboratory. The completed daisy chain quotation includes completed applicable daisy chain quotation items of the daisy chain quotation transmitted to the sub-contracting remote laboratory. The computer-readable instructions also include means for updating a remote laboratory agent bid response to the online educational institution-associated bid request using at least some of the completed applicable daisy chain quotation items and means for transmitting the updated remote laboratory agent bid response to the online educational institution.

A computer system for managing a remote laboratory bid process includes a database system and a server connected to the database system. The server is operable to receive an enablement request relative to a sub-contracting remote laboratory, receive an affiliation request relative to a primary remote laboratory agent, the affiliation request requesting that the sub-contracting remote laboratory be affiliated with the primary remote laboratory agent, transmit an online educational institution-associated bid request to the remote laboratory agent, transmit, to the sub-contracting remote laboratory, of a daisy chain quotation associated with the on line educational institution-associated bid request, and receive a completed daisy chain quotation from the sub-contracting remote laboratory. The completed daisy chain quotation includes completed applicable daisy chain quotation items of the daisy chain quotation transmitted to the sub-contracting remote laboratory. The server is also operable to update a remote laboratory agent bid response to the online educational institution-associated bid request using at least some of the completed applicable daisy chain quotation items and transmit the updated remote laboratory agent bid response to the online educational institution.

### BRIEF DESCRIPTION OF THE DRAWINGS

A more complete understanding of the method and system of the present invention may be obtained by reference to the following Detailed Description of Exemplary Embodiments of the Invention, when taken in conjunction with the accompanying Drawings, wherein:

FIGS. 1A-B illustrate an exemplary method for SCRL management;

FIGS. 2A-B illustrate exemplary configuration elements governing utilization and qualification of the SCRLs;

FIGS. 3A-E illustrate a technical database model/schema that may be used in connection with the configuration elements illustrated in FIG. 2A;

FIG. 4 illustrates a technical database model/schema that may be used in connection with the illustrative configuration elements represented in FIG. 2B;

FIGS. 5A-B show an exemplary high-level flow chart that illustrates how an SCRL may be enabled and associated with a primary remote laboratory agent;

FIG. 6 represents a technical database model/schema that may be used in connection with the exemplary SCRL enablement process of FIGS. 5A-B;

FIG. 7 is an exemplary flow chart of how a primary remote laboratory agent may select and include the SCRL(s) into an online educational institution bid request;

FIG. 8 is an exemplary flow chart of how an SCRL may handle a primary-remote laboratory agent-issued daisy-chain quote;

FIG. 9 is an exemplary flow chart of how a primary remote laboratory agent may handle an SCRL daisy-chain-quote response;

FIG. 10 is an exemplary flow chart of how a primary remote laboratory agent may utilize a quotation analysis tool with respect to SCRL-furnished quotations;

FIG. 11 is an exemplary flow chart of how a primary remote laboratory agent may add marginal pricing to accepted SCRL quotations;

FIG. 12 is an exemplary flow chart of how an online educational institution may handle a primary remote laboratory agent's bid response;

FIG. 13 is an exemplary flow chart of how SCRL bill/pay request vouchers may be processed.

FIG. 14 is an exemplary flow chart of how the system and method may be used when a student registers for a course.

### DETAILED DESCRIPTION OF EXEMPLARY EMBODIMENTS OF THE INVENTION

Various embodiments of the invent ion will now be described more fully with reference to the accompanying drawings. The invention may, however, be embodied in many different forms and should not be construed as limited to the embodiments set forth herein. The invention should only be considered limited by the claims as they now exist and the equivalents thereof.

In this Detailed Description, various entities, such as, for example, a sub-contracting remote laboratory (SCRL), a primary remote laboratory agent, and an on line educational institution, are described. It will be understood by those having ordinary skill in the art that, when various actions are described as being performed by one of the various entities, the actions may be being performed by an individual user associated with that entity.

Various specialized work flows that may be implemented by the online educational institution, the primary remote laboratory agent, or SCRL(s) are not discussed in detail in order to avoid obscuring salient aspects of the invention. It will be understood by those having ordinary skill in the art that specialized work flows may be implemented as appropriate without departing from the spirit and scope of the invention.

Various embodiments of the invention provide a comprehensive, web-enabled system and method for facilitating and managing all aspects of SCRL utilization relative to hybrid courses, including SCRL enablement, the remote laboratory bid process, the requisition process, and the course registration process. In various embodiments of the invention, an online educational institution entity is enabled to not only gain access to SCRL utilization via primary remote laboratory agents, but also to establish and configure governance rules for the SCRL utilization.

Information relative to the SCRLs being utilized may be introduced in a structured and configured manner, which allows both visibility and management by the online educational institution. Once the SCRL has been enabled, the SCRL can be utilized in a configured and integrated mode by the primary remote laboratory agents to augment bid responses back to the online educational institution so as to provide visibility and association of specific bid response elements, including, for example, costing/pricing data, with the SCRL.

SCRL bid-response enabling methods utilized in various embodiments of the invention can enable subsequent functionality applicable to purchase requisitions and order processing. As used herein, purchase requisition refers to reserving or registering for a laboratory portion of a course. SCRLs associated with a primary remote laboratory agent's awarded bid response may be enabled to provide purchase-requisition acceptance in an integrated environment for those purchase-requisition elements applicable to the SCRLs.

Various embodiments of the invention also enable an online educational institution to configure and create a purchase order in such a manner as to account for SCRL purchase-order elements and for SCRL direct-bill pay-request voucher processing during the registration of a hybrid course. Embodiments of the invention that enable SCRL purchase-order and voucher bill pay request visibility and processing may enable both individual SCRL performance assessment, as well as direct and indirect financial-payment processing. By parsing purchase-order elements and applicable bill pay request vouchers into sub-records and/or discrete data processing records unto them selves, core data-processing functionality can be applied to both primary remote laboratory agent and SCRL service providers. Various embodiments of the invention provide enhanced visibility and data-processing capabilities to online educational institutions, primary remote laboratory agent, and SCRLs.

Status as an SCRL may be stowed upon a primary remote laboratory agent; in such a case, a given provider of remote laboratories may function both as a primary remote laboratory agent and as an SCRL to the online educational institution. The SCRLs operate in the context of a life cycle process. The life cycle process includes steps ranging from primary remote laboratory agent qualification/selection to bill payment and reporting.

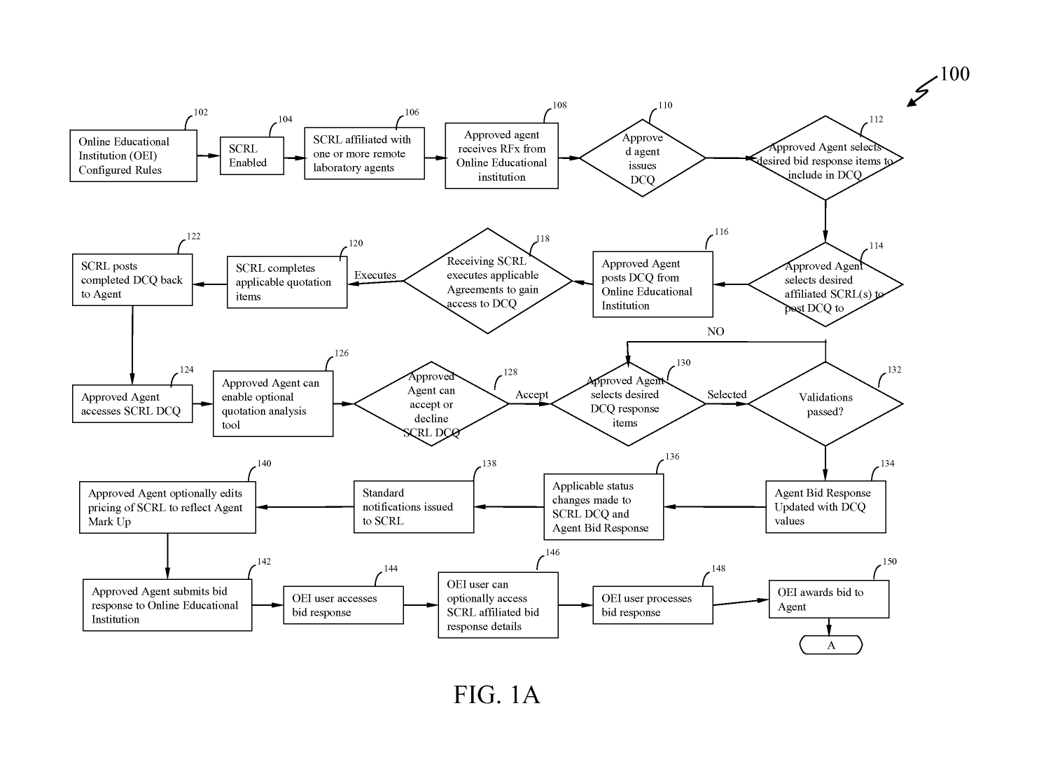

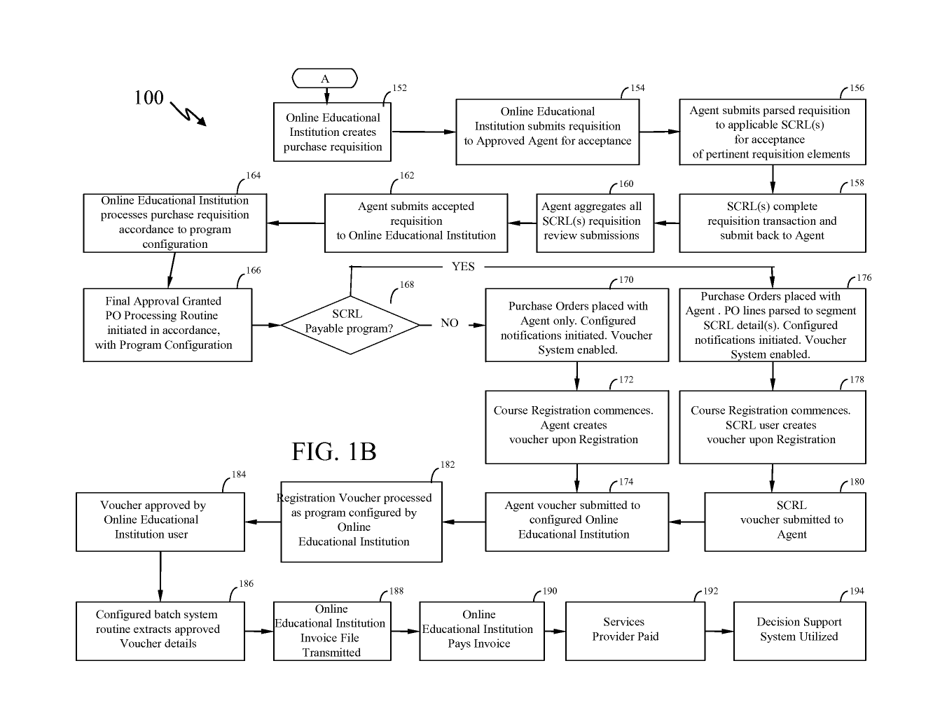

Turning now to the FIGURES, FIGS. 1A-B illustrate exemplary SCRL enablement and management. In FIG. 1A, a flow 100 includes steps 102-150. Steps 102-106 relate to SCRL enablement. Steps 108-142 relate to daisy-chain bid-response processing. Steps 144-150 relate to online educational institution bid response processing. In FIG. 1B, steps 152-170 and 176 relate to purchase requisition processing. Steps 172-174 and 178-184 relate to voucher processing. Steps 186-192 relate to payables processing. Step 194 relates to utilization of a decision support system. Those having ordinary skill in the art will note that some of the decision blocks included in the flow 100 have only a single arrow extending therefrom. In such cases, decisions other than the decision indicated by the arrow extending from the decision block are not considered pertinent to the discussion herein and therefore have been omitted in order to not obscure salient principles of the invention.

The flow 100 begins at step 102, at which step rules are configured by the online educational institution relative to the SCRL. At step 104, the SCRL is enabled and program-configured remote laboratory agent-load requirements are set. At step 106, the SCRL is affiliated with one or more approved remote laboratory agents. At step 108, an approved remote laboratory agent receives a request for quote/request for proposal/request for bid (RFx) from the online educational institution. At step 110, the approved remote laboratory agent decides to issue a daisy-chain quotation. The term daisy chain is used in the context of handling and transmission of work flow elements between entities in which one or more records are parsed from a master record. The parsed records are then transmitted from one entity to another, such that a receiving entity has access to the parsed and transmitted records. Upon further processing, the parsed transmitted records may be reintegrated back into the master record for further handling as part of the work flow. A daisy-chain quotation and a daisy-chain acquisition are examples of how a daisy-chain concept may be used in the context of the work flow process described herein. In response to the decision, at step 110, to issue a daisy-chain quotation, at step 112, the approved remote laboratory agent selects desired bid response items to include in the daisy-chain quotation. The items included in the daisy-chain quotation must include at least one selection of a billable remote laboratory course offering.

From step 112, execution proceeds to step 114. At step 114, the approved remote laboratory agent selects desired affiliated SCRLs to which to post the daisy-chain quotation. At step 116, the approved remote laboratory agent posts the daisy-chain quotation and standard solution notifications are initiated. Standard solution notifications include, for example, so-called on-line dashboard notifications as well as e-mail notifications. From step 116, execution proceeds to step 118. At step 118, a receiving SCRL executes applicable online educational institution agreements to gain access to the daisy-chain quotation. Upon execution of the applicable online educational institution agreements at step 118, execution proceeds to step 120. At step 120, the SCRL completes applicable quotation items. At step 122, the SCRL posts the completed daisy-chain quotation back to the remote laboratory agent.

At step 124, the approved remote laboratory agent accesses the SCRL daisy-chain quotation. From step 124, execution may proceed to either step 126 or 128. If, at step 124, the approved remote laboratory agent determines that an optional quotation analysis too 1 is to be used, execution proceeds to step 126. If, however, the approved remote laboratory agent does not want to use the quotation analysis tool, execution proceeds to directly to step 128. At step 126, the approved remote laboratory agent may enable the optional quotation analysis tools. The quotation analysis tools permit daisy-chain quotation grading and scoring to occur. At step 128, the approved remote laboratory agent may accept or decline the SCRL daisy-chain quotation. If the approved remote laboratory agent accepts the SCRL daisy-chain quotation, execution proceeds to step 130.

At step 130, the approved remote laboratory agent selects daisy-chain quotation response items. For example, the approved remote laboratory agent may select all or less than all of the daisy-chain quotation response items received from an SCRL when certain response items are acceptable to the approved remote laboratory agent and others are not. The selected response items must include at least one voucher able remote laboratory course offering. In response to selection of the desired daisy-chain quotation response items, execution proceeds to step 132. At step 132, a determination is made as to whether all necessary validations have been passed. If it is not determined that all necessary validations have been passed, execution returns to step 130. If, however, it is determined that all necessary validations have passed, execution proceeds from step 132 to step 134.

At step 134, a remote laboratory agent bid response is updated with the daisy-chain quotation values validated at step 132. At step 136, applicable status changes to the SCRL daisy-chain quotation and remote laboratory agent bid response are made. For example, once the selected daisy-chain quotation response items have been accepted by the remote laboratory agent, the status of those items may be changed from pending to accepted. At step 138, standard notifications are issued to the SCRL. At step 140, the approved remote laboratory agent may optionally edit pricing of the SCRL to reflect applicable remote laboratory agent mark-ups. In various embodiments of the invention, the editing of SCRL pricing by the approved remote laboratory agent must not reduce the SCRL pricing and must comply with configured allowable mark-up percentages as set by the online educational institution. From step 140, execution proceeds to step 142. At step 142, the approved remote laboratory agent submits the bid response to the online educational institution.

At step 144, the online educational institution accesses the bid response. At step 146, the approved online educational institution may optionally access via a user interface all SCRL affiliated bid response de tails. At step 148, the online educational institution processes the bid responses. For example, the online educational institution may present bid responses to prospective students interested in registering for remote laboratory courses. At step 150, the online educational institution awards the bid. From step 150, execution proceeds to step 152. At step 152, the online educational institution creates a purchase requisition. At step 154, the online educational institution submits the requisition to the remote laboratory agent for acceptance. At step 156, the remote laboratory agent submits a parsed requisition to the applicable SCRL(s) for acceptance of pertinent requisition elements. At step 158, the applicable SCRL(s) complete the requisition transaction and submit the completed requisition back to the remote laboratory agent.

From step 158, execution proceeds to step 160. At step 160, the remote laboratory agent aggregates all SCRL requisition review submissions. At step 162, the remote laboratory agent submits the accepted requisition to the online educational institution. At step 164, the online educational institution processes the purchase requisition. Processing by the online educational institution of the purchase requisition at step 164 occurs in accordance with program configurations, which may vary according to the remote laboratory course details. At step 166, final approval is granted by the online educational institution, and a purchase order processing routine is initiated.

From step 166, execution proceeds to step 168. At step 168, a determination is made as to whether the current program is an SCRL payable program. An SCRL payable program is defined as a program in which the online educational institution may release funds directly to an SCRL. If it is so determined, execution proceeds to step 176. If it is not so determined, execution proceeds to step 170. At step 176, purchase orders are placed with the remote laboratory agent, purchase order lines are parsed to segment SCRL details, configured notifications are initiated, and a voucher system is enabled. From step 176, execution proceeds to step 178. At step 178, course registration commences and the SCRL creates a voucher upon course registration. At step 180, the SCRL voucher is submitted to the remote laboratory agent.

At step 170, a purchase order is placed with only the remote laboratory agent, configured notifications are initiated, and the voucher system is enabled. From step 170, execution proceeds to step 172. At step 172, course registration commences and the remote laboratory agent creates a voucher in response to course registration.

From both of steps 172 and 180, execution proceeds to step 174. At step 174, the remote laboratory agent voucher is submitted to a configured online educational institution reviewer. From step 174, execution proceeds to step 182. At step 182, the registration voucher submitted at step 174 is processed by the online educational institution. For example, various processing and approval procedures may be implemented as desired by the online educational institution. At step 184, the voucher is approved by the online educational institution.

From step 184, execution proceeds to step 186. At step 186, a configured batch system routine extracts approved voucher details. At step 188, an online educational institution invoice file is transmitted. At step 190, the online educational institution pays the invoice. At step 192, the services provide r(s) are paid (agent and/or remote laboratory course provider). At step 194, a decision support system is utilized.

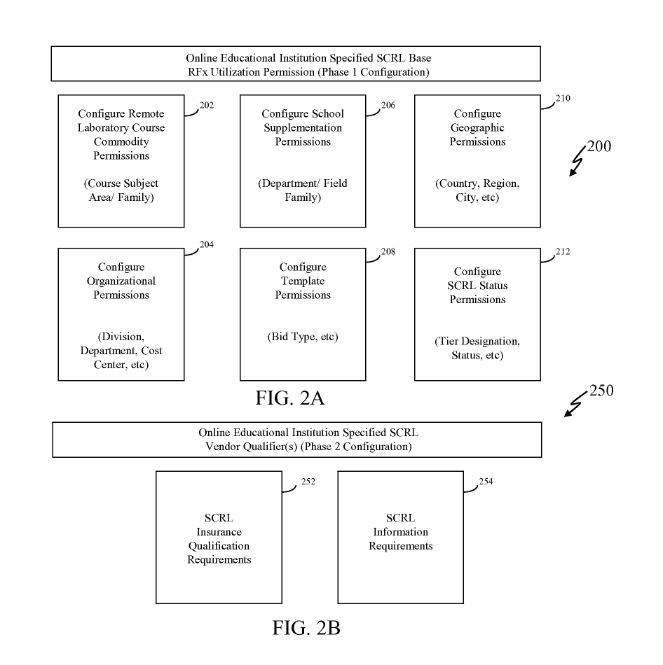

SCRL enablement refers to how SCRLs gain access to the system and subsequently are utilized by both online educational institutions and primary remote laboratory agents. SCRL enablement in accordance with various embodiments of the invention perm its enhanced online educational institution utilization control and management. In embodiments of the invention, a structured management method relative to SCRL utilization can, when enabled, put the online educational institution, as opposed to the primary remote laboratory agent, in control of how SCRLs are to be used. FIGS. 2A-B illustrate exemplary configuration elements governing utilization and qualification of SCRLs.

Configuration elements 200 include remote laboratory course permission configurations 202, organizational permission configurations 204, school supplementation permission configurations 206, template permission configurations 208, geographic permission configurations 210, and primary remote laboratory agent status permission configurations 212.

The remote laboratory course permission configurations 202 include, for example, configurations relative to general course subject area and family (for example, science/life science for subject area/family) and may be established according to a variety of methods desired by the online educational institution. The organizational permission configurations 204 allow, for example, the online educational institution to determine whether SCRLs may be used by the primary remote laboratory agent doing business with the online educational institution in dependence upon the division, school, department, cost center etc. of the online educational institution with whom the primary remote laboratory agent is dealing. The school supplementation commodity permission configuration 206 allow configurations to be set by the online educational institution according to, for example, the offerings or strengths of local colleges and universities to be involved in the remote laboratory courses, for example, chemistry may be configured by the online educational institution to the remote laboratory, while Geology may not. The template permission configurations 208 allow configurations such as those described in relation to other configurations of FIG. 2A to be applied to bid templates and may be, for example, set up according to bid type. The geographic permission configurations 210 allow configurations to be set up according to, for example, country, region, or city. The SCRL status permission configurations 212 allow the online educational institution to set up various statuses of SCRLs and perm it or deny bid participation in accordance with those statuses. For example, an online educational institution could establish that only tier one SCRLs may bid.

FIG. 2B illustrates exemplary configuration elements governing SCRL business requirements. In configuration elements 250, SCRL insurance qualification requirements 252 and SCRL information requirements 254 are shown. The requirements 252 and 254 may be the same as or different from primary remote laboratory agent requirements set up by the online educational institution. For example, the requirements 252 and 254 may be either less stringent or more stringent than the primary remote laboratory agent requirements as desired by the online educational institution.

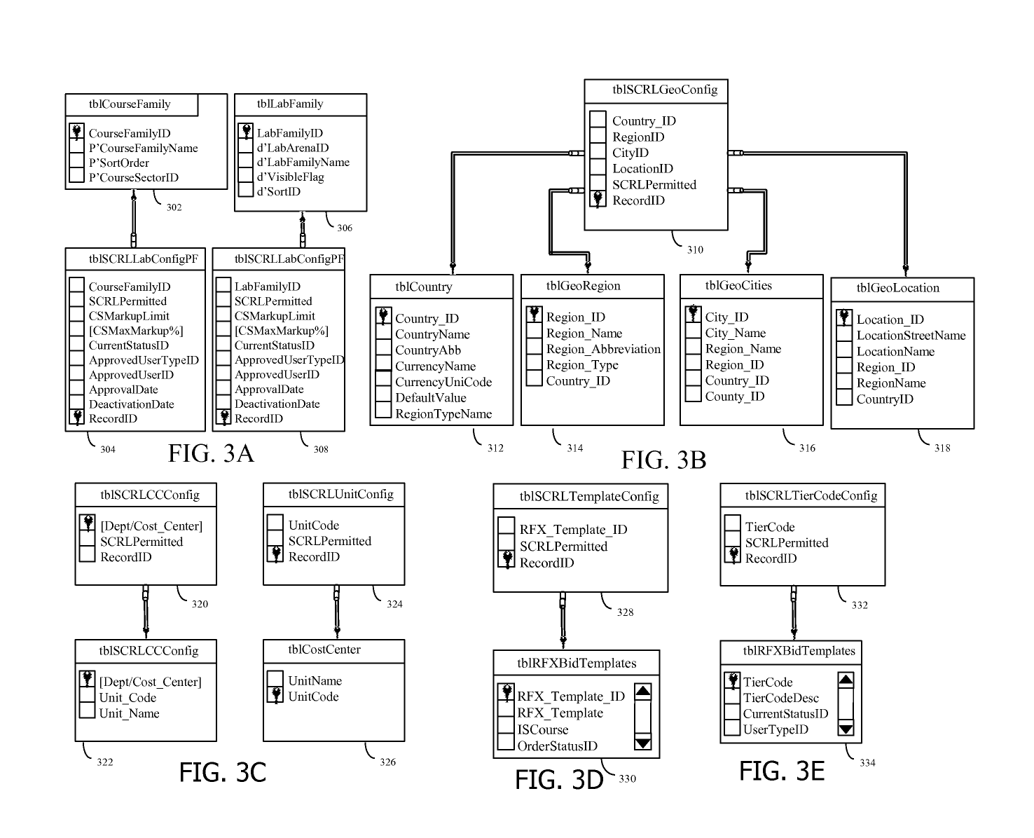

FIGS. 3A-E illustrate a technical database model/schema that may be used in connection with the configuration elements illustrated in FIG. 2A. In particular, FIG. 2A and FIGS. 3A-E illustrate exemplary variables that can be configured by the online educational institution in order to set up a configuration that is most suitable for the online educational institution's business. The exemplary variables shown in FIGS. 2A and 3A-E reflect a broad mix of variables that touch key configuration elements, such as, for example, geography, online educational institution departments, course subject, bid template type, and primary remote laboratory agent status. FIGS. 3A-E are condensed so as to provide details relative to the SCRL.

Examples of data structures for use in SCRL configuration are shown in Tables 113-118. The data structures are illustrated for simplicity as being organized in a table format, with each table including all the fields necessary for SCRL configuration. The tables are related in a hierarchical and/or relational manner, so that all of the necessary information for SCRL configuration can be accurately stored and accessed, as will be described in more detail below in connection with FIGS. 3A-3E. However, it should be understood that other configurations can be included and that the system is not limited to the specific configurations listed in Tables 113-118 or FIGS. 3A-3E.

Tables 113-118 illustrate sample SCRL configurations that can be stored in database tables. The SCRL laboratory configurations shown in Table 113 can be stored in an SCRL laboratory configurations table 304, the SCRL geographic configurations shown in Table 114 stored in an SCRL geographic configurations table 310, the SCRL unit configurations shown in Table 115 stored in an SCRL unit configurations table 324, the SCRL cost center configurations shown in Table 116 stored in an SCRL cost center configurations table 320, the SCRL template configurations shown in Table 117 stored in an SCRL template configurations table 328, and the SCRL tier configurations shown in Table 118 stored in an SCRL tier code configurations table 332.

In FIG. 3A, a database schema for managing SCRL cost and course family configurations includes course family table 302, an SCRL laboratory configurations table 304, a laboratory family table 306, and an SCRL laboratory configurations table 308. The interrelation between the course family table 302 and the SCRL laboratory configurations table 304 is shown in FIG. 3A. The table 302 includes columns for a course family identifier (ID), course family name, sort order, and course sector ID for each course family in the project family table 302. The table 304 includes a course family ID, a deactivation date, an approval date, an approved user ID, an approved user type ID, a current status ID, a primary remote laboratory agent maximal markup percentage, a course sector markup limit, an SCRL permitted field, and the course family ID used in the table 302. Thus, the tables 302 and 304 are interrelated via the course family ID.

The lab family table 306 includes a lab family ID, a lab arena, a lab family name, a visible flag, and a sort ID. The SCRL lab configuration table 308 is analogous to the SCRL configuration lab table 304, the tables 306 and 308 being interrelated via the lab family ID.

In FIG. 3B, geographic configurations for the SCRL are illustrated. The SCRL geographic configurations table 310 includes columns for country ID, region ID, city ID, location ID, SCRL permitted, and record ID. A country table 312, a geographic region table 314, a geographic cities table 316, and a geographic location table 318 are each interrelated with the SCRL geographic configurations table 310 as illustrated in FIG. 3B.

FIG. 3C illustrates SCRL cost center and unit configurations. An SCRL cost center configurations table 320 and a unit configuration table 324 are linked, respectively, to a cost center table 322 and a cost center table 326. FIG. 3D illustrates SCRL template configurations. An SCRL template configuration table 328 is linked to an RFx bid template table 330. The tables 328 and 330 permit SCRL template configurations to be linked to RFx tem plates as discussed above. FIG. 3E includes an SCRL tier code configuration table 332 and an RFx bid template table 334. The tables 332 and 334 permit a tier code assigned to a given SCRL to be linked to a particular RFx bid template.

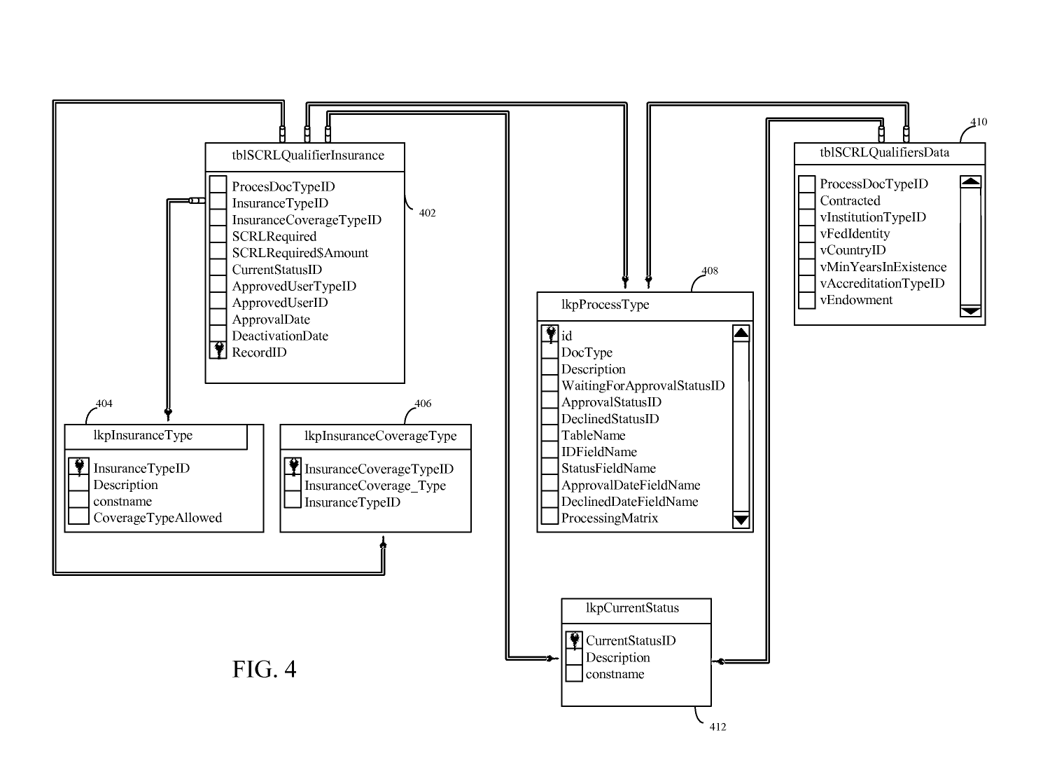

FIG. 4 illustrates a technical database model/schema that may be used in connection with the illustrative configuration elements represented in FIG. 2B. FIGS. 2B and 4 both illustrate online educational institution-specified SCRL primary remote laboratory agent qualifiers. The SCRL primary remote laboratory agent qualifiers are the online educational institution's rules relative to insurance and general business requirements that must be met by an SCRL. FIG. 4 is condensed so as to provide details relative to the SCRL. Those having ordinary skill in the art will recognize that different requirements can be set for each of primary remote laboratory agents and SCRLs.

Examples of data structures for primary remote laboratory agent qualification for an SCRL are shown in Tables 120-125. The data structures are illustrated for simplicity as being organized in a table format, with each table including all necessary fields for SCRL primary remote laboratory agent qualification. Tables 120-125 are related in a hierarchical and/relational manner, so that all necessary information can be accurately stored and accessed, as will be described below in connection with FIG. 4. However, it should be understood that other SCRL primary remote laboratory agent qualifier fields can be included and the system is not limited to the fields listed in Tables 120-125 or FIG. 4.

In FIG. 4, an SCRL qualifiers insurance table 402, an insurance type table 404, an insurance coverage type table 406, a process type table 408, an SCRL qualifiers business table 410, and a current status table 412 are shown. The Tables 402-412 are interrelated as indicated in FIG. 4. Table 120 illustrates sample data that can be stored in the insurance type table 404. Table 121 illustrates sample data that can be stored in the table 406. Table 122 illustrates sample data that can be stored in the table 402. Table 124 illustrates sample data that can be stored in the table 410, Table 124 lists sample values of SCRL business qualifiers that can be stored in table 410. Table 125 lists sample data that can be stored in the table 408.

The SCRL qualifiers insurance table 402 includes various data regarding insurance requirements placed upon the SCRL by the online educational institution. The insurance type table 404 include-s various information relative to the type of insurance required of the SCRL. In similar fashion, the insurance coverage type table 406 includes various data relative to the type of insurance coverage required of the SCRL.

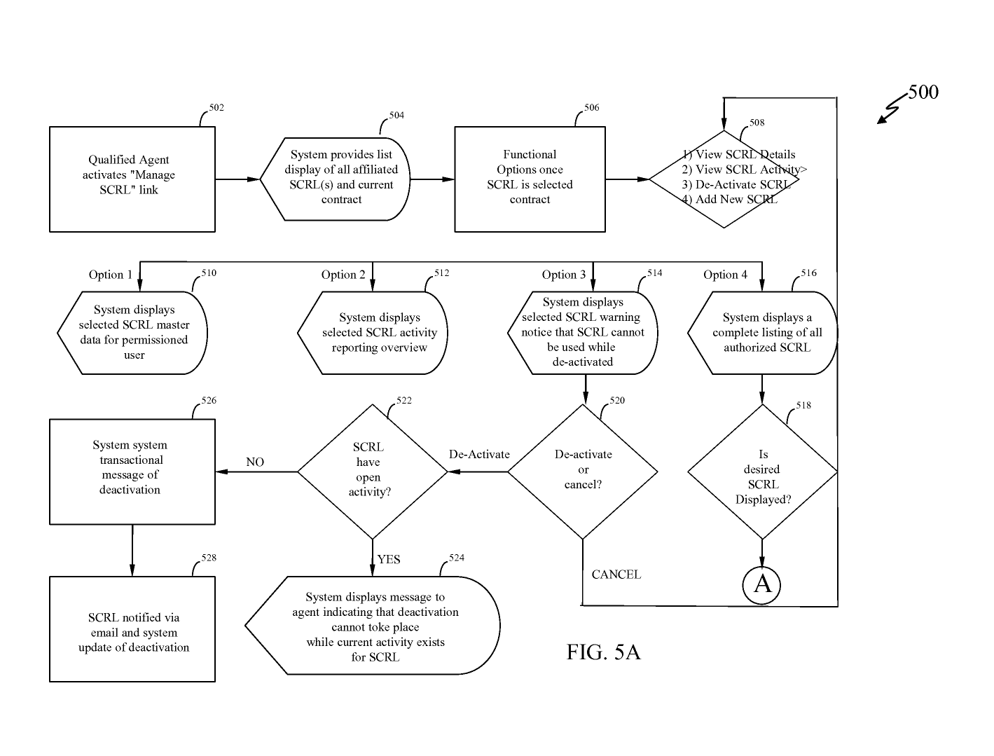

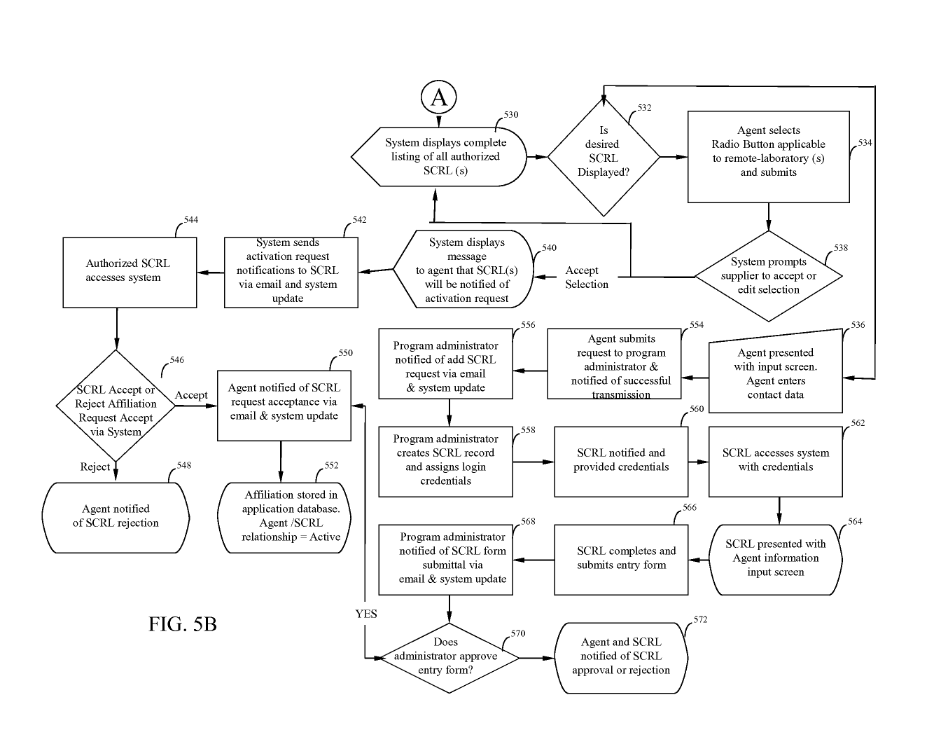

FIGS. 5A-B show an exemplary high-level flow chart that illustrates how an SCRL may be enabled and associated with a primary remote laboratory agent. In an SCRL enablement process, online educational institution configurations may be utilized in conjunction with work flow to govern a controlled SCRL load flow. In an SCRL load flow 500 as illustrated in FIGS. 5A-B, various participating entities may gain visibility and ownership of various process segments applicable to themselves.

The flow 500 begins at step 502. At step 502, a qualified remote laboratory agent activates a Manage SCRL link from a remote laboratory agent home page. At step 504, a list display of all affiliated SCRLs and their current status is provided. At step 506, functional options appear in response to selection of a particular SCRL. At step 508, four exemplary options are presented as follows: 1) view SCRL details; 2) view SCRL activity; 3) de-activate SCRL; and 4) add new SCRL.

From step 508, if option 1) is selected, at step 510, selected SCRL master data for permissioned users of the online educational institution are displayed. In embodiments of the invention, the data displayed at step 510 is read-only data. If, at step 508, option 2) is selected, at step 512, selected SCRL activity reporting overview data are displayed. In embodiments of invention, the data displayed at step 512 is read-only data. If, at step 508, option 3) is selected, at step 514, selected SCRL data, with a warning notice that the SCRL cannot be used while de-activated, are displayed. If, at step 508, option 4) is selected, at step 516, a listing of authorized SCRLs is displayed. From step 514, execution proceeds to step 520. At step 520, de-activation of the SCRL or cancellation of de-activation of the SCRL may be chosen.

From step 520, if cancellation of the de-activation of the SCRL is chosen, execution returns to step 508. If de-activation of the SCRL is chosen, execution proceeds to step 522. At step 522, a determination is made whether the SCRL to be de-activated has open activity. If, at step 522, it is determined that the SCRL to be de-activated has open activity, execution proceeds to step 524. At step 524, a message is displayed to the remote laboratory agent indicating that de-activation cannot take place while current activity exists for the SCRL to be de-activated.

If, at step 522, it is not determined that the SCRL to be de-activated has open activity, execution proceeds to step 526. At step 526, the remote laboratory agent is provided a system transactional message of de-activation. From step 526, execution proceeds to step 528. At step 528, the SCRL is notified via e-mail and the system is updated regarding the de-activation of the SCRL.

From step 516, execution proceeds to step 518. At step 518, a determination is made whether the desired SCRL is being displayed. If it is determined at step 518 that the desired SCRL is being displayed, execution proceeds to step 530. At step 530, a listing of authorized SCRLs is displayed. Those of ordinary skill in the art will appreciate that business considerations may dictate that a complete listing of all authorized SCRLs not be displayed to certain entities utilizing the system.

At step 532, a determination is made whether a desired SCRL is being displayed. If so determined, execution proceeds to step 534. If, at step 532, it is not determined that the desired SCRL is being displayed, execution proceeds to step 536. At step 534, the remote laboratory agent selects the SCRL(s) and submits the selection. At step 538, the remote laboratory agent is prompted to accept or edit selections made by the remote laboratory agent at step 534. If the remote laboratory agent accepts the selections made in step 534, execution proceeds to step 540. If the remote laboratory agent edits these selections, execution returns to step 530.

At step 540, a message is displayed to the remote laboratory agent that the SCRL(s) will be notified of the remote laboratory agent's activation request. At step 542, the activation request notification is sent to the SCRL(s) via e-mail and the system is updated to reflect the activation request by the primary remote laboratory agent to the SCRL(s). It will be appreciated by those having ordinary skill in the art that the activation of an SCRL/remote laboratory agent relationship is not a unilateral mandate from the remote laboratory agent to the SCRL, but rather must be approved by both the SCRL and primary remote laboratory agent. At step 544, the SCRL accesses the system. At step 546, the SCRL may accept or reject the affiliation request. If, at step 546, the SCRL rejects the affiliation request, execution proceeds to step 548. At step 548, the remote laboratory agent is notified of the rejection of the affiliation request by the SCRL.

If, at step 546, the SCRL accepts the affiliation request, execution proceeds to step 550. At step 550, the remote laboratory agent is notified of the SCRL acceptance of the request via e-mail and the system is updated to reflect the SCRL acceptance. At step 552, the affiliation is stored in an application database and the remote laboratory agent/SCRL relationship is designated an active relationship. Although not explicitly illustrated in FIGS. 5A-5B, the process of affiliating a remote laboratory agent and an SCRL can include restraints placed on the SCRL/remote laboratory agent relationship that are similar to those constraints discussed above with respect to the primary remote laboratory agent/online educational institution relationship including, for example, subject area or campus location constraints upon remote laboratory course openings provided by the SCRL to the primary remote laboratory agent.

As noted above, if the desired SCRL is not determined to have been displayed at step 532, execution proceeds to step 536. At step 536, the remote laboratory agent is presented with an input screen and enters pertinent contact data. From step 536, execution proceeds to step 554. At step 554, the remote laboratory agent submits a request to a program administrator and is notified of successful transmission thereof. At step 556, the program administrator is notified of the Add-SCRL request via e-mail and the system is updated. At step 558, the program administrator creates an SCRL record and assigns appropriate log-in credentials. At step 560, the SCRL is notified of the log-in credentials provided at step 558. At step 562, the SCRL accesses the system with the log-in credentials created at step 558.

At step 564, the SCRL is presented with a remote laboratory agent information input screen. At step 566, the SCRL completes and submits an entry form. At step 568, the program administrator is notified of the SCRL form submittal via e-mail and the system is updated. From step 568, execution proceeds to step 570. At step 570, a determination is made whether the administrator has approved of the entry form. If it is determined at step 570 that the administrator has approved the entry form, execution proceeds to step 574. At step 574 the SCRL is activated on the system and standard notifications are provided to the SCRL and the primary remote laboratory agent regarding the activation of the SCRL. From step 574, execution returns to step 532, at which step the desired SCRL will now be displayed and the SCRL affiliation process may commence. If, at step 570, the administrator has not approved the entry form, execution proceeds to step 572. At step 572, the remote laboratory agent and the SCRL are notified of the SCRL approval rejection.

Since by definition SCRLs are not directly solicited to respond to bids, it is only through primary remote laboratory agent affiliation that business can be generated between the online educational institution and the SCRL. In various embodiments of the invention, no relationships can be established without consent of all parties.

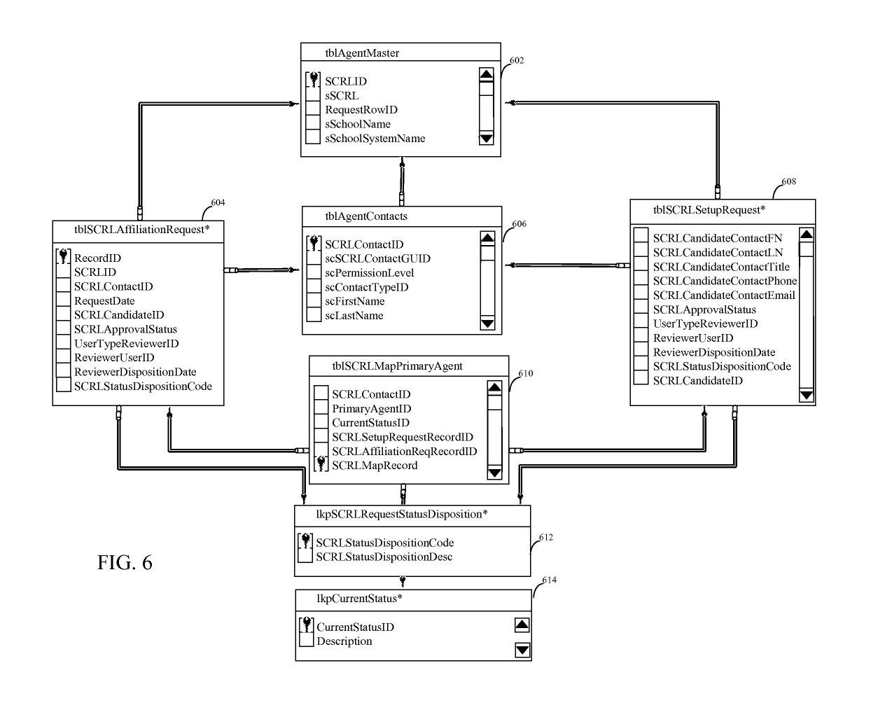

Examples of data structures for use in SCRL enablement and association with a primary remote laboratory agent are shown in Tables 126-129. The data structures are illustrated for simplicity as being organized in a table format, with each table including all the fields necessary for SCRL enablement and association with a primary remote laboratory agent. The tables are related in a hierarchical and/or relational manner, so that all of the necessary information for SCRL enablement and association with a primary remote laboratory agent can be accurately stored and accessed, as will be described in more detail below in connection with FIG. 6. However, it should be understood that other configurations can be included and that the system is not limited to the specific configurations listed in Tables 113-118 or FIG. 6.

Tables 126-129 illustrate sample SCRL enablement data that can be stored in database tables. The SCRL enablement data shown in Table 126 can be stored in an SCRL setup request Table 608. The SCRL enablement data in Table 127 can be stored in an SCRL affiliation request Table 604. The SCRL enablement data in Table 128 can be stored in an SCRL request status disposition Table 612. The SCRL enablement data in Table 129 can be stored in an SCRL map primary remote laboratory agent Table 610.

TABLE 113
tblSCRLLabConfig (db structure view)

| Column Name | Data Type | Length |
|---|---|---|
| CourseFamilyID | int | 4 |
| SCRLPermitted | char | 1 |
| RecordID | int | 4 |

TABLE 114
tblSCRLGeoConfig (db structure view)

| Column Name | Data Type | Length |
|---|---|---|
| RegionID | int | 4 |
| CityID | int | 4 |
| LocationID | int | 4 |
| SCRLPermitted | char | 1 |
| RecordID | int | 4 |

TABLE 115
tblSCRLUnitConfig (db structure view)

| Column Name | Data Type | Length |
|---|---|---|
| UnitCode | varchar | 50 |
| SCRLPermitted | char | 1 |
| RecordID | int | 4 |

TABLE 116
tblSCRLCCConfig (db structure view)

| Column Name | Data Type | Length |
|---|---|---|
| [Dept/Cost_Center] | varchar | 50 |
| SCRLPermitted | char | 1 |
| RecordID | int | 4 |

TABLE 117
tblSCRLTemplateConfig (db structure view)

| Column Name | Data Type | Length |
|---|---|---|
| RFX_Template_ID | int | 4 |
| SCRLPermitted | char | 1 |
| RecordID | int | 4 |

TABLE 118
tblSCRLTierCodeConfig (db structure view)

| Column Name | Data Type | Length |
|---|---|---|
| TierCode | int | 4 |
| SCRLPermitted | char | 1 |
| RecordID | int | 4 |

TABLE 120
lkpInsuranceType (db structure view)

| InsuranceTypeID Description | CoverageTypeAllowed |
|---|---|
| 1 General Liability | 1 |
| 2 Theft | 0 |
| 3 Fire | 1 |
| 4 Personal Injury | 1 |

TABLE 121
lkpInsuranceCoverageType (db structure view)

| Column Name | Data Type | Length |
|---|---|---|
| InsuranceCoverageTypeID | int | 4 |
| InsuranceCoverageType | varchar | 50 |
| InsuranceTypeID | int | 4 |

TABLE 122
tblSCRLQualifiersInsurance (db structure view)

| Column Name | Data Type | Length |
|---|---|---|
| InsuranceTypeID | int | 4 |
| InsuranceCoverageTypeID | int | 4 |
| SCRLRequired | char | 1 |
| SCRLRequired$Amount | money | 8 |
| CurrentStatusID | int | 4 |
| ApproverUserTypeID | int | 4 |
| ApproverUserID | int | 4 |
| ApprovalDate | datetime | 8 |
| DeactivationDate | datetime | 8 |
| RecordID | int | 4 |

TABLE 123
tblSCRLQualifiersData (Table View) (db structure view)

| Column Name | Data Type | Length |
|---|---|---|
| Contracted | char | 1 |
| vInstitutionTypeID | sql_variant | |
| vFedIdentity | char | 1 |
| vCountryID | int | 4 |
| vMinYearsInExistence | numeric | 9 |
| vAccreditationTypeID | char | 1 |
| vEndowment | money | 8 |
| CurrentStatusID | int | 4 |
| ApproverUserTypeID | int | 4 |
| ApproverUserID | int | 4 |
| ApprovalDate | datetime | 8 |
| DeactivationDate | datetime | 8 |
| RecordID | int | 4 |

TABLE 124
tblSCRLQualifiersData (Sample Values) (db structure view)

| Qualifier | Value |
|---|---|
| Contracted | Y |
| vInstitutionTypeID | 2 |
| vFedIdentity | Y |
| vCountryID | 213 |
| vMinYearsInExistence | 10 |
| vAccreditationTypeID | 3 |
| vEndowment | $275,000,000 |
| CurrentStatusID | 1 |
| ApproverUserTypeID | 1 |
| ApproverUserID | 139 |
| ApprovalDate | Apr. 7, 2012 |
| DeactivationDate | NULL |
| RecordID | 1 |

TABLE 125
lkpProcessType (db structure view)

| Column Name | Data Type | Length |
|---|---|---|
| id | int | 4 |
| DocType | varchar | 20 |
| Description | varchar | 250 |
| WaitingForApprovalStatusID | int | 4 |
| ApprovedStatusID | int | 4 |
| DeclinedStatusID | int | 4 |
| TableName | varchar | 128 |
| IdFieldName | varchar | 128 |
| StatusFieldName | varchar | 128 |
| ApprovalDateFieldName | varchar | 128 |
| DeclineDateFieldName | varchar | 128 |
| ProcessingMatrix | char | 1 |
| ApprovalSortPriority | int | 4 |

TABLE 126
tblSCRLSetupRequest (db structure view)

| Column Name Data | Type | Length |
|---|---|---|
| SCRLID | int | 4 |
| UserID | int | 4 |
| Request Date | datetime | 8 |
| SCRLCandidateName | varchar | 100 |
| SCRLCandidateContactFN | varchar | 50 |
| SCRLCandidateContactLN | varchar | 50 |
| SCRLCandidateContactTitle | varchar | 50 |
| SCRLCandidateContactPhone | varchar | 50 |
| SCRLCandidateContactEmail | varchar | 50 |
| SCRLApprovalStatus | int | 4 |
| RecordID | int | 4 |

TABLE 127
tblSCRLAffiliationRequest (db structure view)

| Column Name | Data Type | Length |
|---|---|---|
| SCRLID | int | 4 |
| SCRLContactID | int | 4 |
| RequestDate | datetime | 8 |
| SCRLCandidateID | int | 4 |
| SCRLApprovalStatus | int | 4 |
| UserTypeReviewerID | int | 4 |
| ReviewerUserID | int | 4 |
| ReviewerDispostionDate | datetime | 8 |
| SCRLStatusDispositionCode | int | 4 |
| RecordID | int | 4 |

TABLE 128
lkpSCRLRequestStatusDisposition (db structure view)

| Column Name | Data Type | Length |
|---|---|---|
| SCRLStatusDispositionCode | int | 4 |
| SCRLStatusDispositionDesc | varchar | 25 |

TABLE 129
tblSCRLMapPrimaryAgent (db structure view)

| Column Name | Data Type | Length |
|---|---|---|
| SCRLContactID | int | 4 |
| PrimaryAgentID | int | 4 |
| CurrentStatusID | int | 4 |
| SCRLMapRecord | int | 4 |

TABLE 130
tblSCRLQuoteProfiles (db structure view)

| Column Name | Data Type | Length |
|---|---|---|
| vResponse_ID | int | 4 |
| vUser_ID | int | 4 |
| CurrentStatus_ID | int | 4 |
| DateCreated | datetime | 8 |
| SCRLProfileID | int | 4 |

TABLE 131
tblSCRLQuoteProfilesPost (db structure view)

| Column Name | Data Type | Length |
|---|---|---|
| SCRLProfileID | int | 4 |
| SCRLPrimaryAgentID | int | 4 |
| Post_Date | datetime | 8 |
| PostingRecordID | int | 4 |

TABLE 132
tblSCRLQuoteProfilesItems (db structure view)

| Column Name | Data Type | Length |
|---|---|---|
| SCRLProfileID | int | 4 |
| RFX_Item_ID | int | 4 |
| RecordID | int | 4 |

FIG. 6 represents a technical data base model/schema that may be used in connection with the exemplary SCRL enablement process as defined in FIGS. 5A-B. In FIG. 6, a database schema for SCRL enablement includes a primary remote laboratory agent master Table 602, the SCRL affiliation request Table 604, a primary remote laboratory agent contact Table 606, the SCRL setup request Table 608, the SCRL map primary remote laboratory agent Table 610, the SCRL request status disposition Table 612, and an SCRL current status Table 614. Inter relationships between various of the Tables 602-614 are as illustrated in FIG. 6.

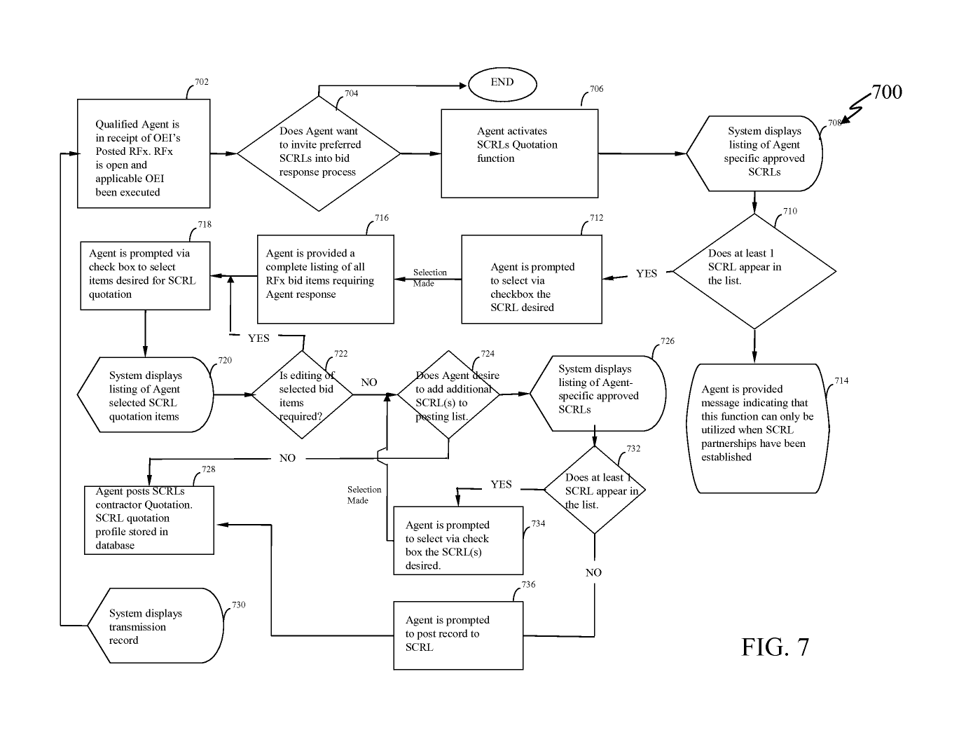

FIG. 7 is an exemplary flow chart of how a primary remote laboratory agent may select and include SCRL(s) into an online educational institution bid request. A flow 700 begins at step 702, at which step a qualified remote laboratory agent is in receipt of an online educational institution's consolidated posted RFx.

At step 704, a determination is made whether the primary remote laboratory agent wants to invite affiliated SCRL(s) into the bid response process. If it is determined that the remote laboratory agent does want to invite affiliated SCRL(s) into the bid response process, execution proceeds to step 706. At step 706, the remote laboratory agent activates an SCRL quotation function. If, at step 704, it is not determined that the remote laboratory agent wants to invite the affiliated SCRL(s) into the bid response process, execution proceeds to step 705, at which step execution ends.

From step 706, execution proceeds to step 708, at which step the system displays a listing of remote laboratory agent affiliated SCRL(s) that are in compliance with the online educational institution qualification criteria. At step 710, a determination is made whether at least one SCRL appears in the list. If it is so determined at step 710, at step 712, the remote laboratory agent is prompted to select the desired SCRL. If, at step 710, it is not determined that at least one SCRL appears in the list, execution proceeds to step 714. At step 714, the remote laboratory agent is provided with a message indicating that the functionality of the flow 700 may only be utilized when SCRL affiliations are active and the SCRL is in compliance with on line educational institution qualification criteria.

From step 712, following selection by the remote laboratory agent of the desired SCRL, execution proceeds to step 716. At step 716, the remote laboratory agent is provided a listing of RFx bid items requiring a remote laboratory agent response. At step 718, the remote laboratory agent is prompted to select items desired for SCRL quotation. From step 718, execution proceeds to step 720, in response to selection by the remote laboratory agent of the desired items. At step 720, a listing of remote laboratory agent-selected SCRL quotation items is displayed. At step 722, a determination is made whether editing of selected bid items is required. If, at step 722, it is so determined, execution returns to step 718. If, at step 722, it is not so determined, execution proceeds to step 724.

At step 724, determination is made whether editing of SCRL(s) is required. If, at step 724, it is so determined, functionality to edit SCRL(s) is activated and execution proceeds to step 726. If, at step 724, it is not determined that the remote laboratory agent desires to add additional SCRL(s) to the posting list, a posting function is activated and execution proceeds to step 728.

At step 726, a listing of other SCRLs not previously selected by the remote laboratory agent is displayed. At step 732, a determination is made whether at least one SCRL appears in the list. If it is so determined, execution proceeds to step 734. At step 734, the remote laboratory agent is prompted to select the SCRL(s) desired. From step 734, in response to selections made by the remote laboratory agent, execution returns to step 724. If, at step 732, it is not determined that at least one SCRL appears in the list, execution proceeds to step 736, at which step the remote laboratory agent is prompted to post a record to the SCRL. From step 736, the posting function is activated and execution proceeds to step 728.

As noted above, execution proceeds from step 724 to step 728 in response to there being no determination that the remote laboratory agent desires to edit SCRL(s) on the posting list. At step 728, the remote laboratory agent posts an SCRL quotation and an SCRL quotation profile is stored in a database. From step 728, execution proceeds to step 730. At step 730, the system displays a transmission record. From step 730, execution returns to step 702.

Although not explicitly depicted in FIG. 7, a primary remote laboratory agent may create standard SCRL quotation profiles that systematically match SCRL(s) with specific bid response elements. For instance, a primary remote laboratory agent could configure a finite group of SCRL(s) for introductory chemistry courses, so that each time the primary remote laboratory agent receives a bid in which that particular bid response element is required, the system automatically generates a specific SCRL quotation profile for the configured SCRL(s). A primary remote laboratory agent may be enabled to create variable SCRL quotation profiles that include a combination of both bid items and selected SCRL(s).

FIG. 7 indicates that SCRL quotation profile items are limited to those contained in the Online educational institution RFx Bid. However, in some embodiments of the invention, the SCRL quotation profile may be expanded to include dynamic items created by the primary remote laboratory agent.

Examples of data structures for use in selection and inclusion of SCRL(s) into an online educational institution bid request are shown in Tables 130-132. The data structures are illustrated for simplicity as being organized in a table format, with each table including all the fields necessary for selection and inclusion of SCRL(s) into the online educational institution bid request. The tables are related in a hierarchical and/or relational manner, so that all of the necessary information for SCRL selection and inclusion can be accurately stored and accessed. However, it should be understood that other configurations can be included and that the system is not limited to the specific configurations listed in Tables 130-132.

Tables 130-132 are exemplary SCRL tables used in connection with the flow 700 of FIG. 7. Tables 130-132 are used for primary storage of bid items. Table 130 includes columns for a response ID, a user ID, a current status ID, a date created, and a profile ID. Table 131 acts as a posting record that contains the primary remote laboratory agent ID, a profile ID, the post date and the posting record. Table 132 may be used to facilitate automatic upload in the event that the SCRL quotation response is acceptable to the primary remote laboratory agent.

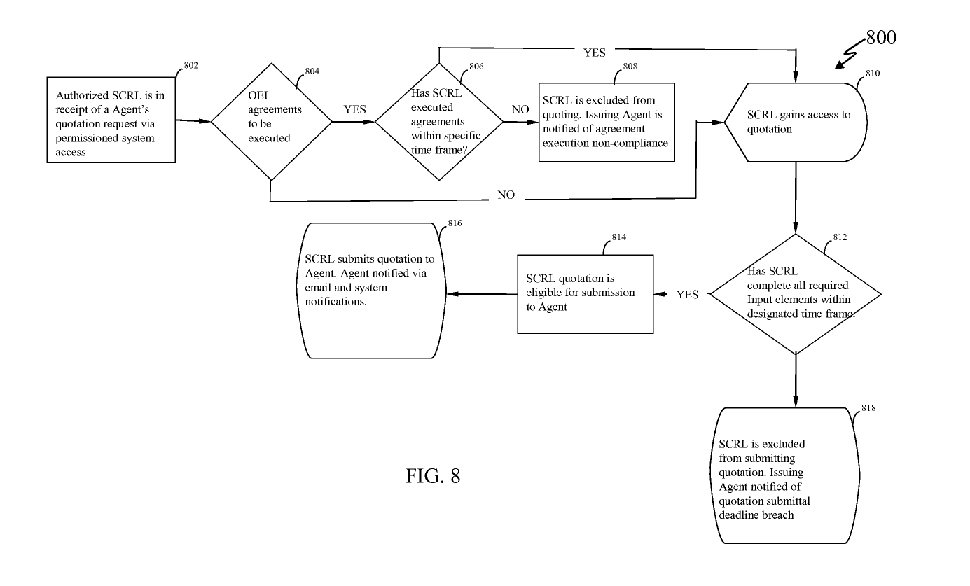

FIG. 8 is an exemplary flow chart of how an SCRL may handle a primary-remote laboratory agent-issued daisy-chain quotation. In FIG. 8, the SCRLs' view of the quotation profile is limited to items selected by primary remote laboratory agents; however, any RFx bid element may be displayed to the SCRL if the primary remote laboratory agent deems it pertinent to the SCRL response.

In FIG. 8, a flow 800 begins at step 802. At step 802, an SCRL is in receipt of a remote laboratory agent's quotation request via permissioned system access. At step 804, a determination is made whether online educational institution agreements need to be executed. For example, an online educational institution may require that a primary remote laboratory agent execute a nondisclosure agreement as a condition of proceeding with the bid process. In similar fashion, the primary remote laboratory agent required to execute the nondisclosure agreement may require the SCRL(s) affiliated with the primary remote laboratory agent that are subject to the daisy-chain quotation process to also to execute the nondisclosure agreement. If it is so determined at step 804, execution proceeds to step 806. At step 806, a determination is made whether the SCRL has executed the required agreements within a specified timeframe. If it is determined, at step 806, that the SCRL has executed the agreements within the specified timeframe, execution proceeds to step 810. At step 810, the SCRL gains access to the quotation. If, at step 804, it is not determined that online educational institution agreements need to be executed, execution proceeds to step 810. At step 808, if it is not determined that the SCRL has executed the agreements within the specified timeframe, the SCRL is excluded from quoting and the remote laboratory agent is notified of agreement-execution non-compliance by the SCRL.

From step 810, execution proceeds to step 812. At step 812, a determination is made whether the SCRL has completed all required input elements within a designated timeframe. If, at step 812, it is determined that the SCRL has completed all of the required input elements within the designated timeframe, execution proceeds to step 814. At step 814, the SCRL quotation is deemed eligible for submission to the remote laboratory agent. At step 816, the SCRL submits the SCRL quotation to the remote laboratory agent and the remote laboratory agent is notified via e-mail and system notification.

If, at step 812, it is not determined that the SCRL has completed all required input elements within the designated timeframe, execution proceeds to step 818. At step 818, the SCRL is excluded from submitting the quotation and the issuing remote laboratory agent is notified of quotation-submittal-deadline breach. It should be understood that in some preferred embodiments, the SCRL input requirements will be supplied in an automated fashion, in which case some of these steps will not apply.

Examples of data structures for use in SCRL handling of a primary-remote laboratory agent-issued daisy-chain quote are shown in Tables 133-142. The data structures are illustrated for simplicity as being organized in a table format, with each table including all the fields necessary for SCRL handling of the primary-remote laboratory agent-issued daisy-chain quote. The tables are related in a hierarchical and/or relational manner, so that all of the necessary information for SCRL configuration can be accurately stored and accessed. However, it should be understood that other configurations can be included and that the system is not limited to the specific configurations listed in Tables 133-142.

Tables 133-142 are exemplary SCRL tables used in connection with the flow 800 shown in FIG. 8.

TABLE 133
tblSCRLQuoteResp (db structure view)

| Column Name | Data Type | Length |
|---|---|---|
| SCRLPostingRecordID | int | 4 |
| SCRLQuoteStatusID | int | 4 |
| SCRLQuoteCreateDate | datetime | 8 |
| SCRLQuoteSubmitDate | datetime | 8 |
| SCRLQuoteResponseID | int | 4 |

TABLE 134
tblSCRLQuoteRespMain (db structure view)

| Column Name | Data Type | Length |
|---|---|---|
| SCRLQuoteResponseID | int | 4 |
| RFX_Item_ID | int | 4 |
| Required_Item | char | 1 |
| SCRL_Response | varchar | 5000 |
| Record_Create_Date | datetime | 8 |
| Last_Save_Date | datetime | 8 |
| RFX_Section_id | int | 4 |
| RFX_Category_id | int | 4 |
| RFX_Response_Complete | char | 10 |
| RFX_Grade | char | 1 |
| RFX_Points | int | 4 |

TABLE 135
tblSCRLQuoteRespLabcoursecontent (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| Identity_Key | int | 4 |
| RFXRespLabcoursecontentRowID | int | 4 |
| Labcoursecontent_Category | varchar | 100 |
| Labcoursecontent_Name | varchar | 100 |
| Labcoursecontent_Description | varchar | 1000 |
| Lab_Count | int | 4 |
| Client_Comments | varchar | 1000 |
| SCRL_User_ID | int | 4 |
| SCRL_User_Contact_ID | int | 4 |
| Record_Create_Date | datetime | 8 |
| Last_Edit_Date | datetime | 8 |
| SCRLLabRecordID | int | 4 |

TABLE 136
tblSCRLQuoteRespDeliverables (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| Identity_Key | int | 4 |
| RFXRespDeliverableRowID | int | 4 |
| DeliverableName | varchar | 50 |
| DeliverableDescription | varchar | 1000 |
| AnticipatedCompletionDate | datetime | 8 |
| BillableDeliverable | char | 1 |
| PaymentAmount | money | 8 |
| PartialPaymentAuthorized | char | 1 |
| Client_Comments | varchar | 1000 |
| SCRL_User_ID | int | 4 |
| SCRL_User_Contact_ID | int | 4 |
| Record_Create_Date | datetime | 8 |
| Last_Edit_Date | datetime | 8 |
| SCRLDelRecordID | int | 4 |

TABLE 137
tblSCRLQuoteRespUnits (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| Identity_Key | int | 4 |
| RFXRespUnitRowID | int | 4 |
| UnitName | varchar | 50 |
| UnitCompletionDescription | varchar | 1000 |
| UnitCount | float | 8 |
| UnitCost | float | 8 |
| LineUnitCost | float | 8 |
| UnitsAuthorized | char | 1 |
| BillableUnits | char | 1 |
| PartialPaymentAuthorized | char | 1 |
| Client_Comments | varchar | 1000 |
| SCRL_User_ID | int | 4 |
| SCRL_User_Contact_ID | int | 4 |
| Record_Create_Date | datetime | 8 |
| Last_Edit_Date | datetime | 8 |
| SCRLUnitRecordID | int | 4 |

TABLE 138
tblSCRLQuoteRespProjExp (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| Identity_Key | int | 4 |
| RFXRespProjExpID | int | 4 |
| CourseExpenseName | varchar | 50 |
| CourseExpenseDescription | varchar | 1000 |
| BillableExpense | char | 1 |
| MaxAmount | money | 8 |
| PartialPaymentAuthorized | char | 1 |
| CurrencyID | int | 4 |
| SCRL_User_ID | int | 4 |
| SCRL_User_Contact_ID | int | 4 |
| Record_Create_Date | datetime | 8 |
| Last_Edit_Date | datetime | 8 |
| SCRLCourseExpID | int | 4 |

TABLE 139
tblSCRLQuoteRespStaffProfiles (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| RFXStaffingProfileID | int | 4 |
| cAnticipatedLabs | int | 4 |
| cBilling | money | 8 |
| Client_Comments | varchar | 1000 |
| SCRL_User_ID | int | 4 |
| SCRL_User_Contact_ID | int | 4 |
| Record_Create_Date | datetime | 8 |
| Last_Edit_Date | datetime | 8 |
| SCRLStaffingRecordID | int | 4 |

TABLE 140
tblSCRLQuoteRespStaffProfilePrice (db structure view)

| Column Name | Data Type | Length |
|---|---|---|
| SCRLStaffingRecordID | int | 4 |
| SCRLStaffingProfilePriceID | int | 4 |
| Anticipated_Labs | float | 8 |
| Bill_Rate | money | 8 |
| Anticipated_Billing | money | 8 |
| RecordCreateDate | datetime | 8 |
| RecordID | int | 4 |

TABLE 141
tblSCRLQuoteRespStaffProfileExpense (db structure view)

| Column Name | Data Type | Length |
|---|---|---|
| SCRLStaffingRecordID | int | 4 |
| SCRLExpenseTypeID | int | 4 |
| SCRLExpenseTypeMax | money | 8 |
| SCRLExpenseID | int | 4 |
| RecordCreateDate | datetime | 8 |
| RecordID | int | 4 |

TABLE 142
tblSCRLQuoteRespPhasing (db structure view)

| Column Name | Data Type | Length |
|---|---|---|
| SCRLQuoteResponseMainID | int | 4 |
| SCRLProfileItemID | int | 4 |
| RFX_Item_ID | int | 4 |
| RFXRespPhaseID | int | 4 |
| Course_Phase_Number | int | 4 |
| Course_Phase_Description | varchar | 3200 |
| Start_Date | datetime | 8 |
| End_Date | datetime | 8 |
| Total_Labs | numeric | 9 |
| Client_Comments | varchar | 1000 |
| SCRL_User_ID | int | 4 |
| SCRL_User_Contact_ID | int | 4 |
| Record_Create_Date | datetime | 8 |
| Last_Edit_Date | datetime | 8 |
| SCRLPhaseRecordID | int | 4 |

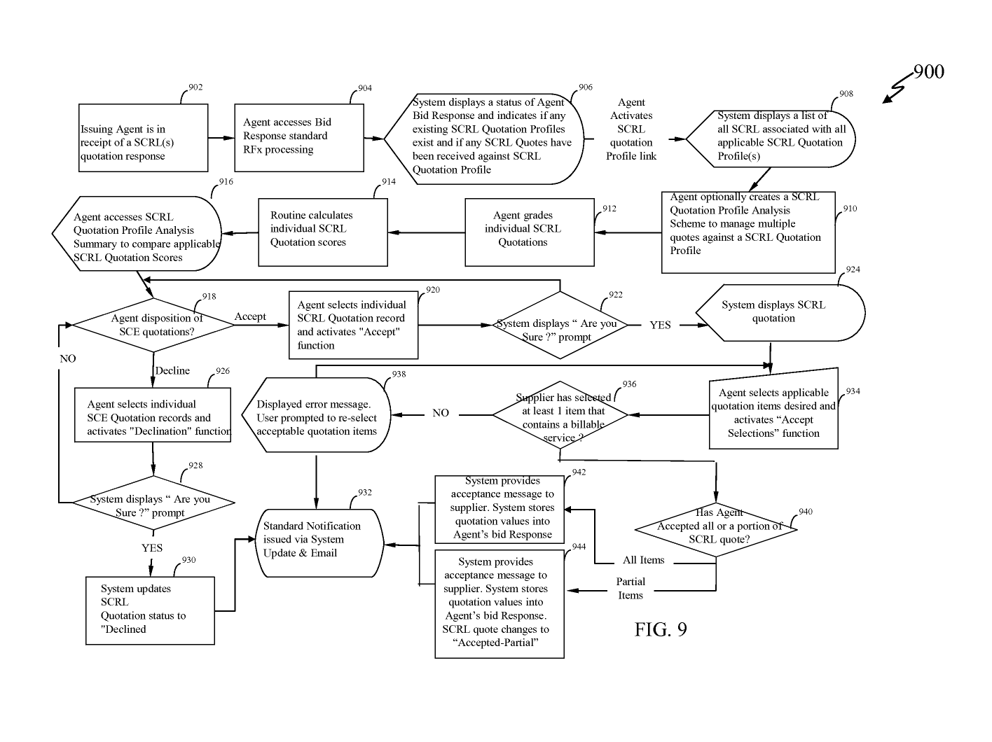

FIG. 9 is an exemplary flow chart of how a primary remote laboratory agent may handle an SCRL daisy-chain-quote response. SCRL quotation response selection and integration back into the primary remote laboratory agent's bid response are illustrated in FIG. 9. In various embodiments of the invention, a database schema and bid-response-item parsing routine permit the primary remote laboratory agent to select desired SCRL quotation elements and integrate the selected SCRL quotation elements back into their proper place holder(s). FIG. 9 does not explicitly illustrate an ability of the SCRL to accept or decline a primary remote laboratory agent's SCRL quotation acceptance; however, this ability is easily configurable in accordance with principles of the invention.

Turning now to FIG. 9, a flow 900 begins at step 902. At step 902, the remote laboratory agent is in receipt of SCRL(s) quotation response. At step 904, the remote laboratory agent accesses the bid response via stand and RFx processing. At step 906, the status of the remote laboratory agent bid response is displayed and it is indicated if any existing quotation profiles exist and if any SCRL quotes have been received against the SCRL quotation profile. Responsive to step 906 and remote laboratory agent activation of an SCRL quotation profile link, execution proceeds to step 908. At step 908, a list of SCRLs associated with applicable SCRL quotation profile(s) is displayed.

At step 910, the remote laboratory agent optionally creates an SCRL quotation profile analysis scheme to manage multiple quotes against a single SCRL quotation profile. In similar fashion to the way that an online educational institution may variably wait remote laboratory agent bid response items, the remote laboratory agent may variably weight bid response items from the SCRL in order to facilitate analysis and potential award. At step 912, the remote laboratory agent grades individual SCRL quotations. At step 914, individual SCRL quotation scores are calculated. At step 916, the remote laboratory agent accesses an SCRL quotation profile analysis summary to compare applicable SCRL quotation scores.

At step 918, a determination is made whether the remote laboratory agent has accepted or declined the SCRL quotation. If, at step 918, the remote laboratory agent accepts the SCRL quotations, execution proceeds to step 920. At step 920, the remote laboratory agent selects an individual SCRL quotation record and activates an Accept function. At step 922, an Are You Sure? prompt is provided. Responsive to an answer of Yes, execution proceeds to step 924. Responsive to a No answer, execution returns to step 918.

At step 924, the SCRL quotation is displayed. In various embodiments of the invention, all items applicable to the remote laboratory agent's bid response have an associated checkbox and the checkbox(es) are inactive for any items in which the bid response item is already encumbered by an accepted alternative SCRL. At step 934, the remote laboratory agent selects applicable quotation items desired and activates an Accept Selections function. At step 936, a determination is made whether the remote laboratory agent has selected at least one item that contains a billable service (laboratory course). If it is not so determined at step 936, execution proceeds to step 938. At step 938, an error message is displayed and a prompt provided to reselect acceptable quotation items. From step 938, execution returns to step 934.

At step 918, if the remote laboratory agent declines the SCRL quotation, execution proceeds to step 926. At step 926, individual SCRL quotation records are selected and a Declination function is activated. In various embodiments of the invention, the individual SCRL quotation records may be selected via corresponding checkboxes. At step 928, an Are You Sure? prompt is displayed. Responsive to an answer of Yes, execution proceeds to step 930. At step 930, the SCRL quotation status is updated to Declined. Responsive to an answer of No execution returns from step 928 to step 918.

Returning to a discussion of step 936, if it is determined at step 936 that the remote laboratory agent has selected at least one item that contains a billable service, execution proceeds to step 940. At step 940, a determination is made whether the remote laboratory agent has accepted all or a portion of the SCRL's quote. If, at step 940, all items of the SCRL quote have been accepted by the remote laboratory agent, execution proceeds to step 942. At step 942, an Acceptance message is provided to the remote laboratory agent and quotation values are stored into the remote laboratory agent's bid response. If, at step 940, the remote laboratory agent has accepted only a portion of the SCRL quote, execution proceeds to step 944. At step 944, an Acceptance message is provided to the remote laboratory agent and quotation values are stored into the remote laboratory agent bid response. In addition, the status of the SCRL quote is changed to Accepted-Partial. From both steps 942 and 944, execution proceeds to step 932. From step 930, execution proceeds to step 932. At step 932, a standard notification is issued via a system update and e-mail. As with all of the figures, some or all of the above steps may be automated by storing rules governing decisions in applicable databases and applying appropriate computer executable code.

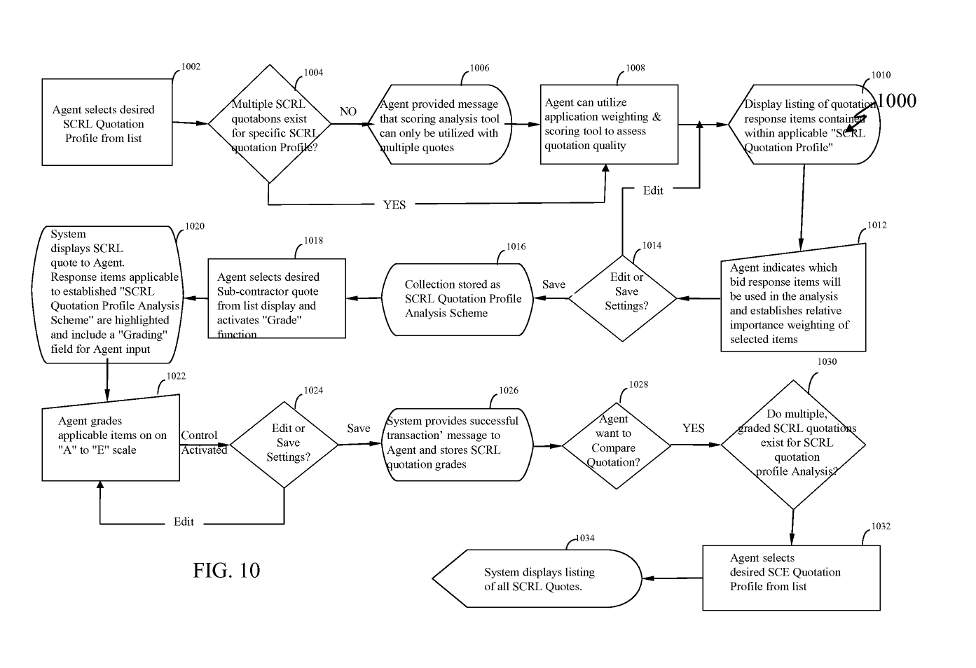

FIG. 10 is an exemplary flow chart of how a primary remote laboratory agent may utilize a quotation analysis tool with respect to SCRL-furnished quotations. FIG. 10 illustrates how primary remote laboratory agents, like online educational institutions, may utilize bid-response scoring tools, which may also be automated, to facilitate the quotation process. FIG. 10 does not explicitly illustrate the ability to configure an automatic upload of the best SCRL score to the primary remote laboratory agent bid response; however, this ability may be configured in accordance with principles of the invention.

In FIG. 10, a flow 1000 begins at step 1002. At step 1002, the remote laboratory agent selects a desired SCRL quotation profile. In various embodiments of the invention, a list of SCRL quotation profiles is displayed via radio buttons and the remote laboratory agent may activate the desired SCRL quotation profile by activating a link associated with a particular radio button. At step 1004, a determination is made whether multiple SCRL quotations exist for the specific SCRL quotation profile. If it is not so determined at step 1004, execution proceeds to step 1006. At step 1006, the remote laboratory agent is provided a message that the scoring analysis tool may only be used with multiple quotes. If, at step 1004, it is determined that multiple quotations exist for the specific SCRL quotation profile, execution proceeds to step 1008.

At step 1008, the remote laboratory agent can utilize an application weighting and scoring tool to grade quotation quality. At step 1010, a listing of quotation response items contained within the applicable SCRL quotation profile is displayed. At step 1012, the remote laboratory agent indicates which bid response items will be used in the analysis and establishes the relative importance weighting of the selected items. At step 1014, the remote laboratory agent is given a choice of whether to edit or save settings. If the remote laboratory agent elects, at step 1014, to edit the settings, execution returns to step 1010. If, at step 1014, the remote laboratory agent elects to save the settings, execution proceeds to step 1016.

At step 1016, a collection including the bid response items to be used in the analysis is stored as an SCRL quotation profile analysis scheme. In various embodiments of the invention, the applicable SCRL quotations are available for grading and scoring analysis. At step 1018, the remote laboratory agent selects the desired SCRL quote(s) and activates a Grade function. For example, a grade of A-E could be used in which a permissioned remote laboratory agent user grades the SCRL(s) according to predefined criteria. At step 1020, an SCRL quote is displayed to the remote laboratory agent, response items applicable to the established SCRL quotation profile analysis scheme are highlighted, and a grading field is included for remote laboratory agent input. At step 1022, the remote laboratory agent grades applicable items on, for example, an A-E scale

In various embodiments of the invention, the ability to save settings is inactive until all required items have been graded by the remote laboratory agent. Once all required items have been graded, the ability to control saving of settings is activated and execution proceeds to step 1024. At step 1024, the remote laboratory agent is given the option to edit or save settings. If, at step 1024, the remote laboratory agent elects to edit the settings, execution returns to step 1022. If, at step 1024, the remote laboratory agent elects to save these settings, execution proceeds to step 1026.

At step 1026, a successful-transaction message is provided to the remote laboratory agent and the SCRL quotation grades are stored. At step 1028, the remote laboratory agent is prompted regarding whet her the remote laboratory agent wants to compare SCRL quotations. If the remote laboratory agent elects, at step 1028, to compare SCRL quotations, execution proceeds to step 1030.

At step 1030, a determination is made whether multiple graded SCRL quotations exist for the SCRL quotation profile analysis scheme. If it is determined that multiple graded SCRL quotations exist for the SCRL quotation profile analysis scheme, execution proceeds to step 1032. At step 1032, the remote laboratory agent selects a desired SCRL quotation profile. In various embodiments of the invention, a list may be displayed via one or more radio buttons that may be activated by the remote laboratory agent as links.

At step 1034, a listing of all SCRL quotes is displayed. In various embodiments of the invention, the display lists all scoreable items, applicable grade, designated item importance weighting, and total item score. Total quotation scores and statistical rankings may also be displayed in the form of a summary table. In addition to the above, the remote laboratory agent may additionally access an analysis summary from a main RFx response menu.

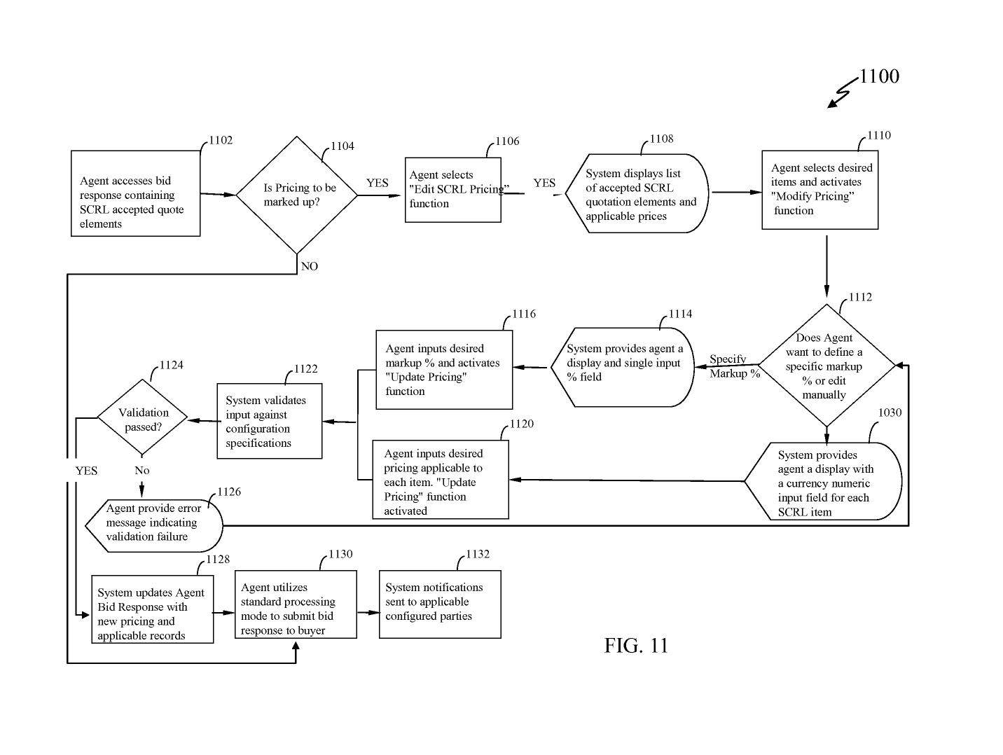

FIG. 11 is an exemplary flow chart that illustrates how a primary remote laboratory agent may add marginal pricing to accepted SCRL quotations. In particular, FIG. 11 illustrates how primary remote laboratory agents may modify or mark up an SCRL quotation to the online educational institution.

In FIG. 11, a flow 1100 begins at step 1102. At step 1102, the remote laboratory agent accesses the bid response containing the SCRL accepted quote elements. At step 1104, the remote laboratory agent may elect to mark up pricing of the accepted quote elements. If, at step 1104, the remote laboratory agent elects to mark up prices, execution proceeds to step 1106. If the remote laboratory agent elects not to mark up prices, execution proceeds to step 1130.

At step 1106, the remote laboratory agent may select an edit-SCRL-pricing function. Responsive to selection of the edit-SCRL-pricing function, execution proceeds from step 1106 to step 1108. At step 1108, a list of accepted SCRL quotation elements and applicable prices is displayed. At step 1110, the remote laboratory agent selects desired items and activates a modify-pricing function. At step 1112, a determination is made whether the remote laboratory agent wants to define a specific markup percentage or edit the markups manually. If, at step 1112, the remote laboratory agent wants to define a specific markup percentage, execution proceeds to step 1114. If, at step 1112, the remote laboratory agent wants to edit the markup manually, execution proceeds to 1118.

At step 1114, the remote laboratory agent is provided a display and an input-percentage field. At step 1116, the remote laboratory agent inputs the desired markup percentage and activates an update-pricing function. At step 1118, the remote laboratory agent is provided a display with a currency numeric input field for each SCRL lab course. At step 1120, the remote laboratory agent inputs the desired pricing applicable to each lab course and the update-pricing function is activated.

From each of steps 1116 and 1120, execution proceeds to step 1122. At step 1122, the input received from either of steps 1116 and 1120 is evaluated against configuration specifications. For example, as illustrated in FIGS. 2A and 3A, an online educational institution may configure a maximal mark-up limit that may be input by a primary remote laboratory agent. At step 1124, a determination is made whether validations performed at step 1122 have been passed or not. If, at step 1124, it is determined that the validations performed at step 1122 have not been passed, the remote laboratory agent is provided an error message indicating validation failure at step 1126. From step 1126, execution returns to step 1112.

If, at step 1124, it is determined that the validations performed at step 1122 have been passed, execution proceeds to step 1128. At step 1128, the system updates the remote laboratory agent bid response with new pricing and applicable database records. At step 1130, the remote laboratory agent utilizes a standard processing mode to submit the bid response to the online educational institution. At step 1132, system notifications are sent to the applicable configured parties.

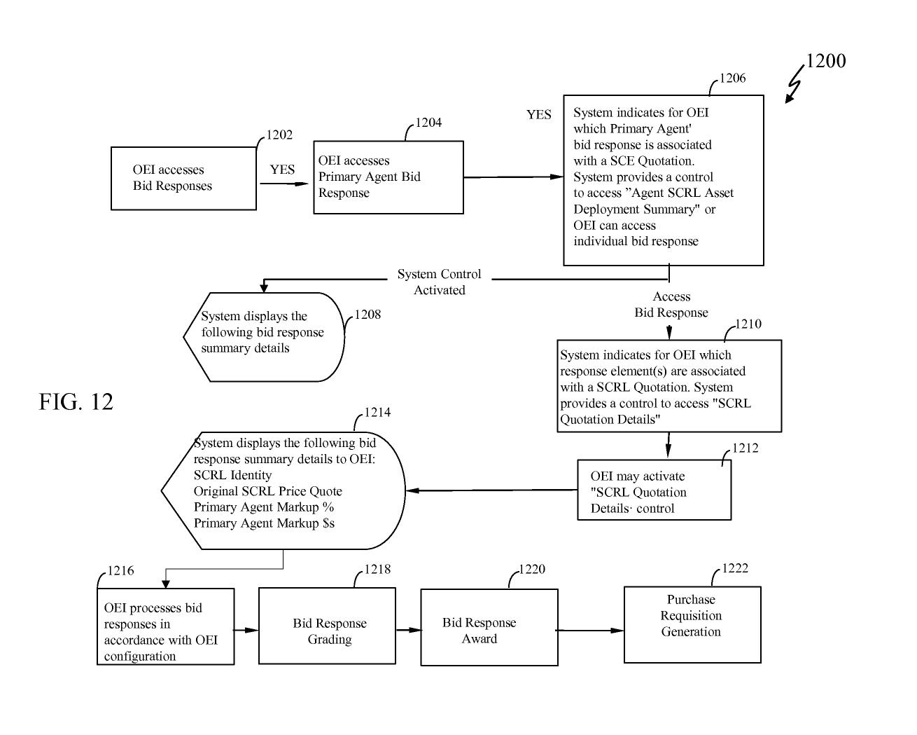

FIG. 12 is an exemplary flow chart of how an online educational institution may handle a primary remote laboratory agent's bid response. FIG. 12 also illustrates how an online educational institution may acquire visibility to SCRL bid response inclusion. FIG. 12 depicts the bid response grading, bid response award, and purchase requisition components of the online educational institution bid response handling phase.

In accordance with principles of the invention, visibility to the online educational institution of SCRL quotation elements yields additional pricing and utilization information that may be viewed by the online educational institution in either an aggregated or a segregated fashion. The pricing and utilization information available to the online educational institution may significantly enhance an online educational institution's decision-making process relative to best response and additionally provide the online educational institution with tools for pricing negotiations.

In FIG. 12, a flow 1200 begins at step 1202. At step 1202, the online educational institution accesses a list of bid responses. In various embodiments of the invention, the accessing of the bid responses by the online educational institution is performed utilizing standard processing functionality. At step 1204, the online educational institution accesses the primary remote laboratory agent bid response. At step 1206, the system provides an additional control to access a remote laboratory agent SCRL asset deployment summary or the online educational institution may access individual bid responses.

If, at step 1206, the online educational institution accesses the individual bid response, execution proceeds to step 1210. At step 1210, the system indicates to the online educational institution which response element(s) are associated with an SCRL quotation and the system provides a control to access SCRL quotation details. At step 1212, the online educational institution can activate the SCRL quotation details control. At step 1214, the system displays bid response item details to the online educational institution. The bid response item details displayed at step 1214 may include, for example: 1) SCRL identity; 2) original SCRL price quote; 3) primary remote laboratory agent markup percentage; and 4) primary remote laboratory agent markup amount. At step 1216, the online education al institution processes the bid responses in accordance with the online educational institution configuration. At step 1218, bid response grading occurs. At step 1220, a bid response award is made. At step 1222, a purchase requisition is generated. Those having skill in the art will recognize that each of steps 1216-1222 may include additional work flows as configured by the online educational institution according to the online educational institution's business needs.

Although FIG. 12 does not explicitly illustrate the ability of the online educational institution to view primary bid response grading/scoring with or without the inclusion of SCRL bid response elements, this ability may be readily implemented without departing from principles of the invention. In similar fashion, the SCRLs could be scored independently if desired.

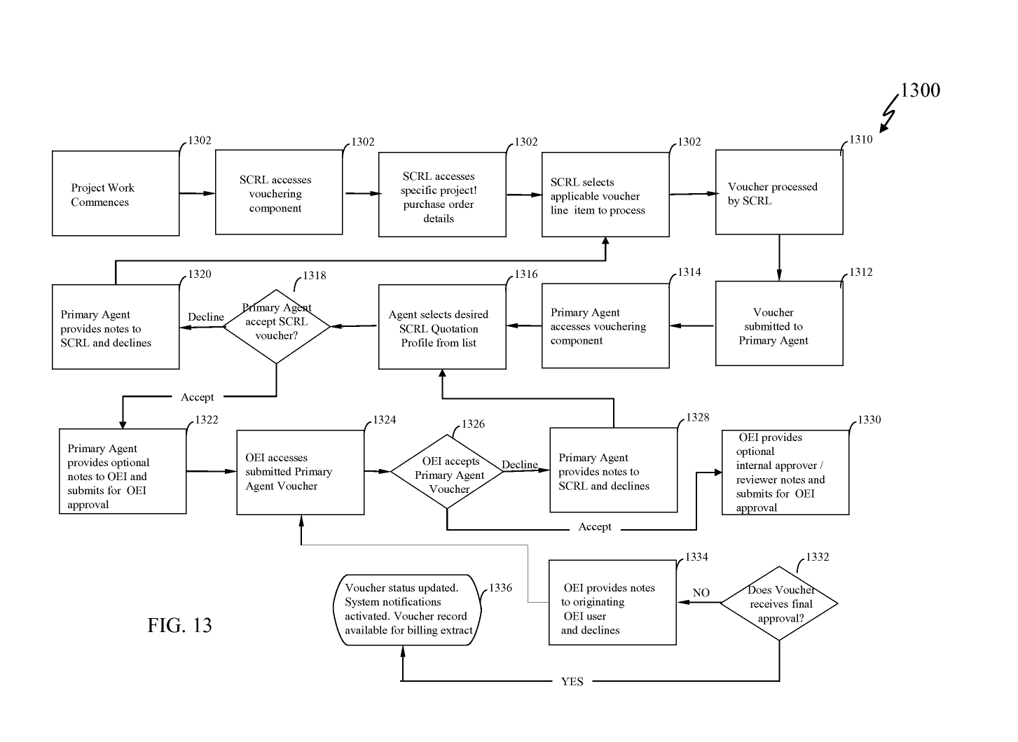

FIG. 13 is an exemplary flow chart of how SCRL bill/pay request vouchers may be processed. FIG. 13 relates to processing of hybrid courses vouchers by the primary remote laboratory agent and SCRL. The ability of SCRLs to process course-provided or registration-completed vouchers initials the vouchering process started without interference by a so-called middle man.

In FIG. 13, a flow 1300 begins at step 1302. At step 1302, a registration for a remote laboratory portion of a hybrid course is completed. At step 1304, the SCRL accesses the vouchering component. At step 1306, the SCRL accesses specific course/purchase order details. At step 1308, the SCRL selects applicable voucher line item(s) to process. At step 1310, the voucher is processed by the SCRL. At step 1312, the voucher is submitted to the primary remote laboratory agent. At step 1314, the primary remote laboratory agent accesses the vouchering component. At step 1316, the primary remote laboratory agent accesses the submitted SCRL voucher. At step 1318, a determination is made whether the primary remote laboratory agent has accepted the SCRL voucher. If, at step 1318, the primary remote laboratory agent has not accepted the SCRL voucher, execution proceeds to step 1320. For example, the primary remote laboratory agent may notice at step 1318 an error in the voucher submitted by the SCRL relative to facts known to the primary remote laboratory agent. Thus, in such a situation, at step 1920, the primary remote laboratory agent provides notes to the SCRL and declines the voucher, which permits the primary remote laboratory agent to avoid having an incorrect voucher being submitted to the online educational institution. At step 1320, the primary remote laboratory agent provides notes to the SCRL and declines the voucher. From step 1320, execution returns to step 1308.

If, at step 1318, the primary remote laboratory agent accepts the SCRL voucher, execution proceeds to step 1322. At step 1322, the primary remote laboratory agent provides optional notes to the online educational institution and submits the voucher for online educational institution approval. In various embodiments of the invention standard notifications are activated. From step 1322, execution proceeds to step 1324. At step 1324, the online educational institution accesses the submitted primary remote laboratory agent voucher. At step 1326, the online educational institution may accept or decline the primary remote laboratory agent voucher. If, at step 1326, the online educational institution accepts the primary remote laboratory agent voucher, execution proceeds to step 1336. If, at step 1326, the online educational institution has not accepted the primary remote laboratory agent voucher, execution proceeds to step 1328. At step 1328, the primary remote laboratory agent provides notes to the SCRL and declines the voucher. From step 1328, execution returns to step 1316. At step 1336, the voucher status is updated and system notifications are activated. In addition, at step 1336, the voucher record is made available for billing extract. As will be appreciated by those having skill in the art, steps 1326, 1328, and 1336 may include numerous steps in accordance with an online educational institution configured workflow. This may include, for example, approval buy the student that is registering for the hybrid course at the online educational institution and is in the process of selecting an SCRL.

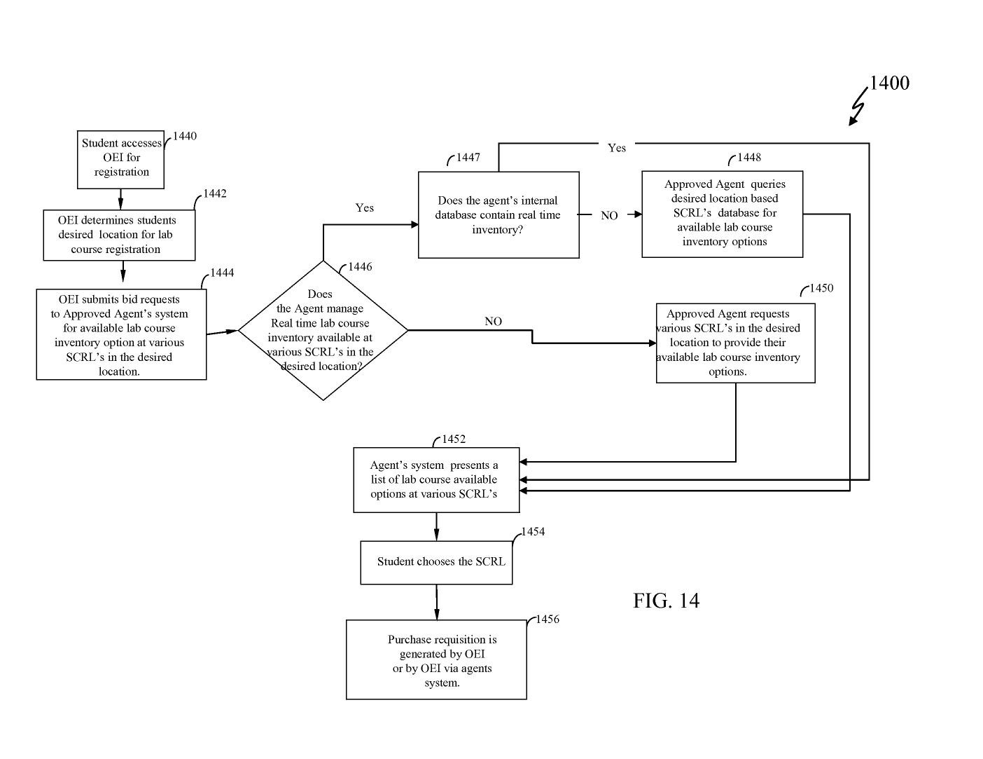

In FIG. 14, a flow 1400 begins at step 1440. FIG. 14 is an exemplary diagram of some embodiments of the invention. At 1440 a student accesses an OEI database, for example via an Internet interface, to explore course options in preparation for course registration. Based on a query initiated by the student, the desired location for the lab potion of a course is ascertained at 1442 and at 1444 a bid request to the Approved Agent's system is initiated to search for available lab portions of courses at or near the desired location. At 1446, if up to date bid items, such as available laboratory slots, etc., exist in the Approved Agent's database then at 1448 the Approved Agent queries the Approved Agent's database and resulting options are presented to the student. At 1446, if up to date bid items, such as available laboratory slots, etc., do not exist in the Approved Agent's database then at 1450 the Approved Agent queries databases at individual SCRL's and resulting options are presented to the student. At 1454 the student selects a specific bid request and at 1456 a purchase requisition is generated.

Although certain modes have been described above, other modes are possible to achieve the same outcome within this invention. For example, in a preferred mode, the SCRL's may pre-populate a database run by the remote laboratory agent with information pertaining to bid item selections such that the bid responses can be automated. For example, the agent may maintain a database of SCRL's including details about courses, locations, times, available slots, cost, accreditation, etc. The SCRL's may periodically update this database. When a student at the online educational institution selects courses at the online educational institution's web portal, the online educational institution's server may send a query to the agent's database. The pre-populated information in the database may then be used by the agent's computer system to generate an automated bid response. In some modes, the remote laboratory agent is computer executable code running on servers at the on line educational institution or at one or more SCRL's.

In one embodiment, the remote laboratory agent comprises computer-executable instructions in a computer readable medium. In other embodiments, the remote laboratory agent comprises a company or non-profit organization that facilitates matching online educational institutions with third party institutions (for example, colleges and universities) for the purpose of providing students of the online educational institution with hands-on laboratory portions of courses at locations near where the students reside.

In some embodiments the bid item selections passed from the online educational institution may include student information that may be utilized by the SCRL or primary remote laboratory agent for screening purposes, such as student grade point average, standardized test scores, grades in pre-requisite courses, and others.

It is understood that in some embodiments the phrase “transmit the remote laboratory agent-associated bid request to the at least one sub-contracting remote laboratory” can comprise the process of executing a query, related to the remote laboratory agent-associated bid request, of a database comprising records pertaining to at least one sub-contracting remote laboratory.

The previous description is of embodiment(s) for implementing the invention and the scope of the invention should not necessarily be limited by this description. The scope of the present invention is instead defined by the following claims and the equivalents thereof.

It is anticipated that in some preferred embodiments, the present invention will be used in conjunction with the system and method described in U.S. patent application 61/853,449, which is incorporated by reference.

We claim:

1. A method of facilitating a remote laboratory bid process, the method comprising:
on at least one server computer comprising a processor and memory, establishing online educational institution configurations governing sub-contracting remote laboratory utilization by at least one remote laboratory agent in the remote laboratory bid process;
generating, by the at least one server computer, an online educational institution-associated bid request utilizing at least a portion of bid item selections of a stored bid item list, wherein the online educational institution-associated bid request is associated with the online educational institution configurations;
transmitting, by the at least one server computer, the online educational institution-associated bid request to the remote laboratory agent for solicitation of a remote laboratory agent bid response to be generated with the bid item selections utilized in the online educational institution-associated bid request;
generating, by the at least one server computer, a remote laboratory agent-associated bid request utilizing at least a portion of the bid item selections utilized in the online educational institution-associated bid request;
wherein the step of generating the online educational institution-associated bid request further comprises:
receiving online educational institution-associated bid request data from an online educational institution for the online educational institution-associated bid request; and
storing the online educational institution-associated bid request data within fields associated with at least a portion of the bid item selections.

2. The method of claim 1, further comprising:
receiving the remote laboratory agent bid response; and
wherein the remote laboratory agent bid response includes bid response data within fields associated with at least a portion of the bid item selections utilized in the online educational institution-associated bid request.

3. The method of claim 2, further comprising:
receiving a sub-contracting remote laboratory bid response; and
wherein the sub-contracting remote laboratory bid response includes bid response data within fields associated with at least a portion of the bid item selections utilized in the remote laboratory agent-associated bid request.

4. The method of claim 3, further comprising transmitting the remote laboratory agent bid response to the online educational institution upon completion of all required ones of the fields by the remote laboratory agent.

5. The method of claim 4, further comprising transmitting the sub-contracting remote laboratory bid response to the at least one remote laboratory agent upon completion of all required ones of the fields by the sub-contracting remote laboratory.

6. The method of claim 3, wherein the step of transmitting the remote laboratory agent-associated bid request comprises selecting the at least one sub-contracting remote laboratory to receive the remote laboratory agent-associated bid request using the remote laboratory agent-associated bid request data.

7. The method of claim 6, wherein the step of selecting the at least one sub-contracting remote laboratory further comprises:
maintaining sub-contracting remote laboratory information associated with the at least one sub-contracting remote laboratory; and
comparing the remote laboratory agent-associated bid request data with the sub-contracting remote laboratory information to select the at least one sub-contracting remote laboratory.

8. The method of claim 2, wherein the step of transmitting the online educational institution-associated bid request comprises selecting the at least one remote laboratory agent to receive the online educational institution-associated bid request using the online educational institution-associated bid request data.

9. The method of claim 8, wherein the step of selecting the at least one remote laboratory agent further comprises:
maintaining remote laboratory agent information associated with the at least one remote laboratory agent; and
comparing the online educational institution-associated bid request data with the remote laboratory agent information to select the at least one remote laboratory agent.

10. The method of claim 1, further comprising:
receiving the sub-contracting remote laboratory bid response;
receiving the remote laboratory agent bid response;
receiving a remote laboratory agent bid award;
transmitting a purchase requisition to the at least one remote laboratory agent;
transmitting a parsed purchase requisition to the sub-contracting remote laboratory; and
wherein the parsed purchase requisition is a subset of the purchase requisition.

11. The method of claim 10, wherein the purchase requisition is submitted to the at least one remote laboratory agent for purposes of acceptance.

12. The method of claim 10, wherein the parsed purchase requisition is submitted to the sub-contracting remote laboratory for purposes of acceptance.

13. The method of claim 10, further comprising:
receiving a completed parsed purchase requisition from the sub-contracting remote laboratory; and
generating a completed purchase requisition.

14. The method of claim 13, further comprising:
generating an online educational institution-associated purchase order to the at least one remote laboratory agent;
generating a remote laboratory agent-associated purchase order to the sub-contracting remote laboratory;
responsive to a determination that the sub-contracting remote laboratory may be paid directly by an online educational institution, generating an online educational institution-associated purchase order to the sub-contracting remote laboratory.

15. The method of claim 1, wherein the online educational institution configurations comprise course permission configurations, the course permission configurations configured to allow sub-contracting remote laboratory utilization based at least in part upon course subject and field.

16. The method of claim 1, wherein the online educational institution configurations comprise organizational permission configurations, the organizational permission configurations configuring allowed sub-contracting remote laboratory utilization based at least in part upon at least one of an academic department, course subject area, course level, or cost center of an online educational institution.

17. The method of claim 1, wherein the online educational institution configurations comprise geographic permission configurations, the geographic permission configurations configuring allowed sub-contracting remote laboratory utilization based at least in part upon geographic location.

18. The method of claim 1, wherein the online educational institution configurations comprise primary remote laboratory agent status permission configurations, the primary remote laboratory agent status permission configurations permitting or denying sub-contracting remote laboratory bid participation based at least in part upon a status of the at least one remote laboratory agent.

19. The method of claim 1, wherein the online educational institution configurations comprise sub-contracting remote laboratory cost configurations, the sub-contracting remote laboratory cost configurations specifying at least one of a primary remote laboratory agent maximal markup percentage and a primary remote laboratory agent markup limit.

20. A computer system for facilitating a bid process for a remote laboratory portion of a course involving an online educational institution, a remote laboratory agent, and at least one sub-contracting remote laboratory, the computer system comprising:
a database system for maintaining a configurable pre-established bid item list and a bid template for the remote laboratory portion of a course;
wherein the bid template includes bid item selections selected from the bid item list;
a server connected to the database system and connect able to an online educational institution, the remote laboratory agent, and optionally the at least one sub-contracting remote laboratory; and
wherein the server is operable to:
establish online educational institution configurations governing sub-contracting remote laboratory utilization by at least one remote laboratory agent in the remote laboratory bid process;
generate an online educational institution-associated bid request utilizing the bid template, wherein the online educational institution-associated bid request is associated with the online educational institution configurations;
transmit the online educational institution-associated bid request to the remote laboratory agent;
generate a remote laboratory agent-associated bid request via a parsing of the online educational institution-associated bid request;
wherein the remote laboratory agent-associated bid request is subject to the online educational institution configurations permitting bid participation by the at least one sub-contracting remote laboratory,
receive or generate a sub-contracting remote laboratory bid response to the remote laboratory agent-associated bid request; and
receive or generate a remote laboratory agent bid response, the remote laboratory agent bid response incorporating, at least in part, data from the sub-contracting remote laboratory bid response.

21. A method of facilitating a remote laboratory bid process, the method comprising: on at least one server computer comprising a processor and memory, establishing online educational institution configurations governing sub-contracting remote laboratory utilization by at least one remote laboratory agent in the remote laboratory bid process;
generating, by the at least one server computer, an online educational institution-associated bid request utilizing at least a portion of bid item selections of a stored bid item list, wherein the online educational institution-associated bid request is associated with the online educational institution configurations;
transmitting, by the at least one server computer, the online educational institution-associated bid request to the remote laboratory agent for solicitation of a remote laboratory agent bid response to be generated with the bid item selections utilized in the online educational institution-associated bid request;
generating, by the at least one server computer, a remote laboratory agent-associated bid request utilizing at least a portion of the bid item selections utilized in the online educational institution-associated bid request;
executing a query, by the at least one server computer, using the remote laboratory agent-associated bid request, of a database comprising records pertaining to at least one sub-contracting remote laboratory for solicitation of a sub-contracting remote laboratory bid response to be generated with the bid item selections utilized in the remote laboratory agent-associated bid request; and
wherein the executing a query using the remote laboratory agent-associated bid request is subject to the online educational institution configurations permitting bid participation by the at least one sub-contracting remote laboratory.
